(19) United States
(12) Patent Application Publication
(10) Pub. No.: US 2026/0236763 A1
(43) Pub. Date: Aug. 13, 2026

(54) DATA AUGMENTATION AND/OR DRAFT SETS OF TOKENS SELECTION TO ACCELERATE MACHINE LEARNING

(71) Applicant: NVIDIA Corporation, Santa Clara, CA (US)

(72) Inventors: Liwei Ma, Beijing (CN); Nikita Korobov, Munchen (DE)

(21) Appl. No.: 19/056,130

(22) Filed: Feb. 18, 2025

(30) Foreign Application Priority Data
Feb. 13, 2025 (CN) 2025101653554

(51) Int. Cl. G06N 3/08

(52) U.S. Cl. CPC G06N 3/08

(57) ABSTRACT

In various examples, systems and methods are provided for obtaining predictions from one or more neural networks. For example, one or more draft sets of one or more tokens may be selected for input into one or more neural networks based at least on multiple amounts of processing time and multiple numbers of accepted tokens associated with multiple numbers of tokens. The one or more neural networks may then use the one or more draft sets to generate one or more predictions.

### BACKGROUND

A language model (e.g., large language model (LLM), vision language model (VLM), multi-modal language model (MMLM), etc.) may generate a single next token (e.g., word, subword, phoneme, etc.) based on an original input (e.g., a prompt) at each iteration or step. To speed up inference, speculative decoding may be used, which allows the language model to accept multiple tokens based on the original input sequence and a batch of draft sets of tokens. When performing speculative decoding, the batch of draft sets of tokens is used to construct speculative input sequences by appending the draft sets to the original input sequence. One or more of the draft sets may include multiple tokens (e.g., representing multiple words, subwords, phonemes, etc.), which means if the language model accepts a speculative input sequence including one of these draft sets, the language model may select multiple tokens in a single step. The language model generates predictions (e.g., in parallel) based on the speculative input sequences and uses these predictions to determine which of the speculative input sequences to accept in parallel. While speculative decoding may be used to reduce inference time, some speculative decoding techniques require modification of the structure of the language model, re-training of the model, and/or reliance on one or more additional machine learning models (e.g., one or more neural networks). In other instances, a number of draft sets of tokens accepted per step (e.g., acceptance rate) by the language model may be low, which constrains the amount of acceleration of inferencing performed by the language model.

### SUMMARY

Embodiments of the present disclosure relate to data augmentation and/or draft sets of tokens selection to accelerate machine learning. Systems and methods are disclosed that generate augmented training data to be used to train a neural network (e.g., an LLM, VLM, MMLM, etc.) that uses speculative decoding, such as lookahead speculative decoding. In at least one embodiment, the augmented training data generated by the systems and methods includes input sequences generated using tokens obtained from a portion of a training sequence. In at least one embodiment, the systems and methods identify a current token within the training sequence, which is located before a token to be predicted, referred to as a golden token. In at least one embodiment, the systems and methods generate the input sequences by selecting one or more tokens from a portion of the training sequence and appending the selected token(s) to any tokens positioned before the current token in the training sequence. In at least one embodiment, the systems and methods train the neural network (e.g., an LLM, VLM, MMLM, etc.) to use the input sequences to predict the golden token. In at least one embodiment, the systems and methods use a loss value calculated for the input sequences to update the neural network (e.g., an LLM, VLM, MMLM, etc.) during training.

In contrast to conventional systems, which require modification of the structure or architecture of the neural network (e.g., an LLM, VLM, MMLM, etc.), retraining of the neural network, and/or reliance on one or more additional machine learning models (e.g., one or more neural networks), in at least one embodiment, the systems and methods may train the neural network using the augmented data without modifying the architecture of the neural network, without retraining the neural network, and without relying on one or more additional machine learning models. In at least one embodiment, using the augmented training data to train a neural network (e.g., an LLM, VLM, MMLM, etc.) may increase a number of tokens accepted per step during inference.

Systems and methods are disclosed that select one or more sets of draft tokens (also referred to as one or more draft sets) to be used to generate input sequences for a neural network (e.g., an LLM, VLM, MMLM, etc.) to use to generate output. In at least one embodiment, the systems and methods select the draft set(s) based on a number of tokens included in the draft set(s). In at least one embodiment, the systems and methods select(s) the draft set(s) by obtaining a marginal profit associated with a number of tokens included in each draft set in a batch of tokens (e.g., a batch of draft sets). Then, the systems and methods select a draft set associated with a greatest marginal profit, generate an input sequence including the selected draft set to be input into the neural network (e.g., an LLM, VLM, MMLM, etc.), and determine whether to continue selecting additional draft sets of tokens. In at least one embodiment, the systems and methods determine whether to continue selecting additional draft sets based at least in part on a marginal cost associated with the number of tokens included in the selected draft set. In at least one embodiment, the systems and methods determine whether to continue selecting additional draft sets based at least in part on a comparison of a threshold value to a ratio of the marginal profit associated with the number of tokens included in the selected draft set to the marginal cost associated with the number of tokens included in the selected draft set.

In contrast to conventional systems, which do not select draft set(s) to use to generate input sequence(s) to provide to a neural network (e.g., an LLM, VLM, MMLM, etc.) based on marginal costs or profits associated with numbers of tokens included in the draft sets, the systems and methods may use such marginal costs and marginal profits to determine which draft sets in a batch to provide to a neural network (e.g., an LLM, VLM, MMLM, etc.), which may increase a speed of inference, avoid performing inference with respect to draft sets having a low likelihood of being accepted, and/or allow resources to be allocated more efficiently because the threshold value may be used to determine a tradeoff between an estimated acceptance rate (as reflected in the marginal profit) and an estimated processing time (as reflected in the marginal cost).

### BRIEF DESCRIPTION OF THE DRAWINGS

The present systems and methods for data augmentation and/or draft sets of tokens selection to accelerate machine learning are described in detail below with reference to the attached drawing figures, wherein:

FIG. 1 is a block diagram illustrating an example system, in accordance with some embodiments of the present disclosure;

FIG. 2 is a block diagram illustrating an example data augmentation process, in accordance with some embodiments of the present disclosure;

FIG. 3 is a block diagram illustrating an example of input sequences generated for an example training or ground truth sequence, in accordance with some embodiments of the present disclosure;

FIG. 4 is a block diagram illustrating a training process of using augmented data generated using the data augmentation process of FIG. 2 to train a language model (e.g., LLM, VLM, MMLM, etc.), in accordance with some embodiments of the present disclosure;

FIG. 5 illustrates an example process of using lookahead speculative decoding to predict one or more next tokens, in accordance with some embodiments of the present disclosure;

FIG. 6 is a block diagram illustrating a workflow that may used to collect information related to speculative decoding, in accordance with some embodiments of the present disclosure;

FIG. 7 is a block diagram illustrating a process of allocating tokens of a draft set, sequence, or batch to slots to be input into a language model, in accordance with some embodiments of the present disclosure;

FIG. 8 is a flow diagram showing a method for training a neural network to perform text prediction using augmented data, in accordance with some embodiments of the present disclosure;

FIG. 9 is a flow diagram showing the method for collecting information to be used to select draft sets of tokens at inference time, in accordance with some embodiments of the present disclosure;

FIG. 10 is a flow diagram showing a method for selecting draft sets of tokens at inference time of a language model, in accordance with some embodiments of the present disclosure;

FIG. 11 illustrates a processor with modules for use in implementing at least some embodiments of the present disclosure;

FIG. 12 illustrates a driver and/or runtime including one or more libraries to provide one or more application programming interfaces (APIs) for use in implementing at least some embodiments of the present disclosure;

FIG. 13A is a block diagram of an example generative language model system suitable for use in implementing at least some embodiments of the present disclosure;

FIG. 13B is a block diagram of an example generative language model that includes a transformer encoder-decoder suitable for use in implementing at least some embodiments of the present disclosure;

FIG. 13C is a block diagram of an example generative language model that includes a decoder-only transformer architecture suitable for use in implementing at least some embodiments of the present disclosure;

FIG. 14 is a block diagram of an example computing device suitable for use in implementing at least some embodiments of the present disclosure; and

FIG. 15 is a block diagram of an example data center suitable for use in implementing at least some embodiments of the present disclosure.

### DETAILED DESCRIPTION

Systems and methods are disclosed related to data augmentation and/or draft sets of tokens selection to accelerate machine learning. Such machine learning may include processes related to artificial intelligence and/or one or more neural networks (e.g., one or more LLMs, VLMs, MMLMs, etc.), which may be trained to use speculative decoding to infer text for applications, such as chatbots, virtual assistants, machine translation, content creation, label generation, image segmentation, summarization, sentiment analysis, code generation, text completion, question answering, personalized recommendations, creative writing, and/or other types of applications. Although LLMs are primarily referenced herein, and depicted in the figures, this is not intended to be limiting, and other types of language models (e.g., VLMs, MMLMs, large action models (LAMs), etc.) and/or other machine learning model types may be used without departing from the scope of the present disclosure.

At least one embodiment includes systems and methods to augment data used to train one or more neural networks (e.g., LLMs, VLMs, MMLMs, etc.) to perform text generation. In at least one embodiment, the systems and methods generate augmented training data to be used to train a neural network that uses speculative decoding, such as lookahead speculative decoding. In at least one embodiment, the augmented training data generated by the systems and methods includes input sequences generated using tokens obtained from a portion of a training sequence. In at least one embodiment, the systems and methods identify a current token within the training sequence, which is located before a token to be predicted, referred to as a golden token. In at least one embodiment, the systems and methods generate the input sequences by selecting one or more tokens from a portion of the training sequence and appending the selected token(s) to any tokens positioned before the current token in the training sequence. In at least one embodiment, the systems and methods select sets of tokens from a window and construct one or more batches of input sequences using the selected sets of tokens.

In at least one embodiment, the systems and methods train the neural network to use the input sequences to predict the golden token. In at least one embodiment, the systems and methods use a loss value calculated for the input sequences to update the neural network during training. By constructing multiple input sequences and using the input sequences to predict the golden token during training, a number of tokens accepted per step during inference by the neural network (e.g., LLM, VLM, MMLM, etc.) may be increased without altering a structure of the neural network. In at least one embodiment, the systems and methods may train a neural network using augmented data to fine-tune the neural network to cause the neural network to accept tokens at a higher rate, relative to if the neural network is not fine-tuned. In contrast to other systems, which may require modification of the structure of the neural network, retraining of the neural network, and/or reliance on one or more additional machine learning models (e.g., one or more neural networks), in at least one embodiment, the systems and methods may train the neural network using the augmented data without modifying or retraining the neural network and without relying on one or more additional machine learning models.

At least one embodiment includes systems and methods to select one or more draft sets of tokens to be used to generate input sequences for a neural network (e.g., an LLM, VLM, MMLM, etc.) to use to perform inferencing and generate output. In at least one embodiment, the systems and methods receive a batch of draft sets of tokens and select one or more of the draft sets to input into the neural network based on a number of tokens included in the draft sets. In at least one embodiment, the systems and methods select the draft set(s) from the batch by obtaining a marginal profit associated with a number of tokens included in each draft set. In at least one embodiment, for a particular number of tokens, the marginal profit is calculated based at least in part on historical acceptance rates of draft sets of tokens including at least the particular number of tokens. Then, the systems and methods select a draft set associated with a greatest marginal profit, generate an input sequence including the selected draft set for input into the LLM, and determine whether to continue selecting additional draft sets of tokens.

In at least one embodiment, the systems and methods determine whether to continue selecting additional draft sets of tokens based at least in part on a marginal cost associated with the number of tokens included in the selected draft set. In at least one embodiment, for a particular number of tokens, the marginal cost is calculated based at least in part on historical processing times associated with processing one or more batches including draft sets of tokens that included up to the particular number of tokens. In at least one embodiment, for a particular number of tokens, the marginal cost may be a difference between a first average amount of processing time per token calculated based at least in part on one or more first amounts of time used to process batches of draft sets of tokens each having up to the particular number of tokens, and a second average amount of processing time per token calculated based at least in part on one or more second amounts of time used to process batches of draft sets of tokens each having up to one fewer than the particular number of tokens. In at least one embodiment, the systems and methods determine whether to continue selecting additional draft sets of tokens based at least in part on a comparison of a threshold value to a ratio of the marginal profit associated with the number of tokens included in the selected draft set to the marginal cost associated with the number of tokens included in the selected draft set. In at least one embodiment, for a particular number of tokens, the marginal cost is an estimation of cost (or execution time) associated with performing inferencing if the length of a draft set is increased by another token (e.g., to the number of tokens included in the selected draft set).

In contrast to conventional systems, which do not select draft sets of tokens to use to generate input sequences to provide to a neural network (e.g., an LLM, VLM, MMLM, etc.) based on marginal costs or profits associated with numbers of tokens included in the draft sets of tokens, the systems and methods may use such marginal costs and marginal profits to determine which draft sets of tokens in a batch to provide to a neural network, which may increase a speed of inference, avoid performing inference with respect to draft sets of tokens having a low likelihood of being accepted, and/or allow resources to be allocated more efficiently because the threshold value may be used to determine a tradeoff between an estimated acceptance rate (as reflected in the marginal profit) and an estimated processing time (as reflected in the marginal cost). In another example, an inferencing speed of a neural network (e.g., an LLM, VLM, MMLM, etc.), that has been trained as described above, may be reduced (e.g., optimized) by dynamically balancing draft set lengths input into the neural network during inferencing according to their marginal profits. The ratio may be used to allocate available memory and/or computational budgets during inferencing to improve (e.g., maximize) inferencing efficiency.

In at least one embodiment, a computer-implemented method as described herein includes selecting one or more selected draft sets of tokens to be input into one or more neural networks based at least on multiple amounts of processing time and multiple numbers of accepted tokens associated with multiple numbers of tokens included in the one or more selected draft sets of tokens. A draft set may be intermediate information (e.g., representing text, a word, multiple words, sub-words, phonemes, a character, an image pixel, sound, a video pixel, a voxel, etc.) predicted by a neural network and/or one or more other processes, a token may be a unit of information (e.g., representing text, a word, multiple words, sub-words, phonemes, a character, an image pixel, sound, a video pixel, a voxel, etc.), and an input sequence, which is input to a neural network for processing, may include one or more tokens. The method further includes causing the one or more neural networks to use the one or more selected draft sets of tokens to generate one or more predictions. Text may thereby be generated by the one or more neural networks, for example, with reduced latency and/or without requiring alterations to a structure of the one or more neural networks.

Lookahead speculative decoding is a version of speculative decoding that increases inference speed without requiring changes to neural network structure because lookahead speculative decoding leverages existing capabilities of a neural network to generate informed predictions by leveraging the outputs of the neural network. In lookahead speculative decoding, a batch of draft sets of tokens is generated and used to generate input sequences that are provided to a neural network as input. Multiple draft sets of tokens may be predicted in parallel, allowing the neural network (e.g., an LLM) to evaluate multiple potential continuation paths of text per iteration. The neural network performs inferencing with respect to the draft sets of tokens in the batch in parallel, and selects one of the draft sets of tokens (e.g., as the next word or words in a sequence) as an output. Because the draft sets of tokens may include more than one new token to be added to a sequence, speculative decoding allows text prediction to advance by more than one step per inferencing iteration, which reduces a number of steps needed to produce a result, thereby decreasing inference time. However, lookahead speculative decoding efficiency may be constrained by low token acceptance rates (e.g., a number of draft sets of tokens accepted by the LLM per inferencing step).

In at least one embodiment, an acceptance rate of lookahead speculative decoding, used in conjunction with an LLM, may be increased by using augmented training data as described herein to train and/or fine-tune the LLM to predict a next ground truth token in a training sequence based on multiple input sequences all associated with that next ground truth token, and/or to predict more than one next ground truth token based on input sequences formed using multiple tokens selected from a portion of the training sequence. In addition, when the trained LLM is used to infer text, a draft set length to be used during inferencing may be determined to optimize inferencing efficiency. By implementing training and inferencing techniques as described herein, an acceptance rate of the LLM may be increased while latency may be reduced during inferencing. For example, a neural network (e.g., an LLM, VLM, MMLM, etc.) may be trained using augmented data to fine-tune the neural network to cause the neural network to accept tokens at a higher rate, relative to when the neural network is not fine-tuned. In another example, an inferencing speed of a language model (e.g., that has been trained as described above) may be optimized by dynamically balancing draft set lengths input to the LLM according to their profits during inferencing.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or a model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications-such as NVIDIA's TensorRT), and/or enterprise management data for telemetry (e.g., including identity, metrics, health checks, and/or monitoring). The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software. By way of non-limiting examples, the LLM(s) 130, the LLM functionality 124, the data augmentation functionality 126, the draft set selection functionality 128, and/or one or more other operations described herein may be deployed as one or more microservices, such as those described herein. By way of additional non-limiting examples, at least a portion of one or more of the methods 800-1000 may be performed by one or more microservices, such as those described herein. One or more microservices, such as those described herein, may be used to implement at least one neural network, augment training data as described herein, use the augmented training data to train at least one neural network as described herein, to select draft sets of tokens to be used by one or more neural networks to perform inferencing, and/or to perform other operations such as those described herein.

In some embodiments, the system and methods described herein may be deployed in a talking or smart kiosk application. For example, a kiosk, tablet, smart display, or other device may include one or more onboard processors (e.g., CPUs, GPUs, deep learning accelerators, SoCs) and memory and/or storage (e.g., for storing the model, the image database, etc.). In some embodiments, the kiosk/tablet/display may communicate (e.g., using one or more network interface cards (NICs) and/or data processing units (DPUs)) with one or more locally hosted servers/computing devices and/or with one or more remotely located servers/computing devices (e.g., in one or more data centers). In such examples, the kiosk may communicate with the machine learning model(s) (e.g., language model, LLM, VLM, MMLM, diffusion model, transformer model, NeRF, DNN, etc.) and/or the image database hosted on the local and/or remote servers using one or more APIs-such as, without limitation, REST APIs. By way of non-limiting examples, a kiosk, tablet, smart display, or other device, such as those described herein, may implement the LLM(s) 130, the LLM functionality 124, the data augmentation functionality 126, the draft set selection functionality 128, and/or one or more other operations described herein. By way of additional non-limiting examples, at least a portion of one or more of the methods 800-1000 may be performed by a kiosk, tablet, smart display, or other device, such as those described herein. A kiosk, tablet, smart display, or other device, such as those described herein, may be used to implement at least one neural network, augment training data as described herein, use the augmented training data to train at least one neural network as described herein, to select draft sets of tokens to be used by one or more neural networks to perform inferencing, and/or to perform other operations such as those described herein. The LLM(s) 130, the LLM functionality 124, the data augmentation functionality 126, the draft set selection functionality 128, the method 800, the method 900, the method 1000, at least a portion of the system 100, and/or other components described herein by used to implement a talking or smart kiosk application, such as those described herein. In at least one embodiment, a kiosk, tablet, smart display, or other device, such as those described herein, may communicate with the LLM(s) 130, the LLM functionality 124, the data augmentation functionality 126, the draft set selection functionality 128, and/or other functionality described herein. In one or more embodiments, the system and methods described herein may be deployed in a gaming application. For example, a gaming console, PC, tablet, or other gaming device may include one or more onboard and/or remote processors (e.g., CPUs, GPUs, deep learning accelerators, SoCs) and memory and/or storage (e.g., for storing the game model, game assets, player data, etc.). These devices may use one or more machine learning models (e.g., diffusion models, transformer models, neural rendering field (NeRF) models, language models (e.g., LLMs, VLMs, MMLMs, etc.), DNNs, etc.) to enhance gameplay, generate real-time dynamic content, and personalize user experiences based on in-game behavior or pre-stored player profiles. In some embodiments, the system may be deployed in a cloud gaming environment (e.g., NVIDIA's GeFORCE NOW). In such cases, a client device (e.g., a smart display, tablet, or gaming controller) may be used to interact with the game, while the machine learning model(s) and/or visual rendering may occur on one or more remotely located servers/computing devices (e.g., in one or more data centers). The language model, AI processing, and rendering described herein may operate in the cloud, processing player inputs received from an end-user device(s) (e.g., based on controller, keyboard, mouse, joystick, AR/VR/MR/etc. inputs), generating appropriate in-game responses, rendering the content, and sending or transmitting the content to the end-user device(s). During receiving and/or sending the data to and from the end-user or edge device(s), one or more data processing units (DPUs) and/or network interface cards (NICs) may be used. By way of non-limiting examples, a gaming console, PC, tablet, and/or other gaming device, such as those described herein, may be used to implement the LLM(s) 130, the LLM functionality 124, the data augmentation functionality 126, the draft set selection functionality 128, and/or one or more other operations described herein. By way of additional non-limiting examples, at least a portion of one or more of the methods 800-1000 may be performed by a gaming console, PC, tablet, and/or other gaming device, such as those described herein. A gaming console, PC, tablet, and/or other gaming device, such as those described herein, may be used to implement at least one neural network, augment training data as described herein, use the augmented training data to train at least one neural network as described herein, to select draft sets of tokens to be used by one or more neural networks to perform inferencing, and/or to perform other operations such as those described herein. The LLM(s) 130, the LLM functionality 124, the data augmentation functionality 126, the draft set selection functionality 128, the method 800, the method 900, the method 1000, at least a portion of the system 100, and/or other components described herein by used to implement gaming and/or a gaming application, such as those described herein. In at least one embodiment, the LLM(s) 130, the LLM functionality 124, the data augmentation functionality 126, the draft set selection functionality 128, and/or other functionality described herein, may be used to enhance gameplay, generate real-time dynamic content, personalize user experiences based on in-game behavior or pre-stored player profiles, process player inputs received from an end-user device(s), generate appropriate in-game responses, render content, send or transmit the content to the end-user device(s), and/or perform other operations, such as those described herein.

In some embodiments, the system and methods described herein may be deployed in a video conferencing application. For example, a video conferencing device, such as a dedicated conferencing unit, computer, tablet, and/or smartphone, may include one or more onboard processors (e.g., CPUs, GPUs, deep learning accelerators, SoCs) and memory and/or storage (e.g., for storing the video, audio, or other communication-related data). The system may use the machine learning model(s) (e.g., diffusion models, transformer models, neural rendering field (NeRF) models, language models (e.g., LLMs, VLMs, MMLMs, etc.)) to enhance video conferencing functionality, including real-time or near real-time transcription, diarization, language translation, automatic speech recognition (ASR), and/or background noise reduction. In one or more embodiments, the system may enable users to interact with the video conferencing platform using natural language inputs. For example, users may issue voice commands to schedule, join, or leave meetings, or to manage participants and screen sharing. During receiving and/or sending the data to and from the end-user or edge device(s), one or more data processing units (DPUs) and/or network interface cards (NICs) may be used. By way of non-limiting examples, a video conferencing device (e.g., a dedicated conferencing unit, computer, tablet, smartphone, and/or other type of communication device), such as those described herein, may be used to implement the LLM(s) 130, the LLM functionality 124, the data augmentation functionality 126, the draft set selection functionality 128, and/or one or more other operations described herein. By way of additional non-limiting examples, at least a portion of one or more of the methods 800-1000 may be performed by a video conferencing device (e.g., a dedicated conferencing unit, computer, tablet, smartphone, and/or other type of communication device), such as those described herein. A video conferencing device (e.g., a dedicated conferencing unit, computer, tablet, smartphone, and/or other type of communication device), such as those described herein, may be used to implement at least one neural network, augment training data as described herein, use the augmented training data to train at least one neural network as described herein, to select draft sets of tokens to be used by one or more neural networks to perform inferencing, and/or to perform other operations such as those described herein. The LLM(s) 130, the LLM functionality 124, the data augmentation functionality 126, the draft set selection functionality 128, the method 800, the method 900, the method 1000, at least a portion of the system 100, and/or other components described herein by used to implement video conferencing and/or a video conferencing application, such as those described herein. In at least one embodiment, the LLM(s) 130, the LLM functionality 124, the data augmentation functionality 126, the draft set selection functionality 128, and/or other functionality described herein, may be used to enhance video conferencing functionality, for example, by providing real-time or near real-time transcription, diarization, language translation, automatic speech recognition (ASR), background noise reduction, interaction between users and a video conferencing platform using natural language inputs, and/or perform other operations, such as those described herein.

In some embodiments, the system and methods described herein may be deployed in a robotics application. For example, a robot or robotic system may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). The robotic system may use these processors to execute one or more machine learning models (e.g., language models) that allow it to perform complex tasks autonomously or semi-autonomously, such as interacting with and/or manipulating static and/or dynamic objects, or navigating environments using sensors such as cameras, LiDAR, RADAR, ultrasonic sensors, and more. The system may use sensor fusion techniques to combine data from multiple sensors (e.g., cameras, infrared, LiDAR, RADAR, accelerometers) to create a comprehensive model of the robot's surroundings. This data may be processed locally on the robot or sent to remote servers for more computationally intensive tasks, such as 3D mapping or SLAM (Simultaneous Localization and Mapping). In one or more embodiments, data from individual robots (e.g., sensor data, task status, or environmental conditions) may be uploaded to the cloud, where centralized AI models can analyze and distribute optimized commands to an entire fleet. In some embodiments, the machine learning model(s) (e.g., language models, VLMs, LLMs, MMLMs, diffusion models, NeRF models, DNNs, etc.) described herein may be used to allow the robot to perceive and reason about the environment and/or communicate with one or more other robots and/or persons in an environment. In some embodiments, the robot may communicate (e.g., using one or more network interface cards (NICs) and/or data processing units (DPUs)) with one or more locally hosted servers/computing devices and/or with one or more remotely located servers/computing devices (e.g., in one or more data centers). By way of non-limiting examples, a robot or robotic system, such as those described herein, may be used to implement the LLM(s) 130, the LLM functionality 124, the data augmentation functionality 126, the draft set selection functionality 128, and/or one or more other operations described herein. By way of additional non-limiting examples, at least a portion of one or more of the methods 800-1000 may be performed by a robot or robotic system, such as those described herein. A robot or robotic system, such as those described herein, may be used to implement at least one neural network, augment training data as described herein, use the augmented training data to train at least one neural network as described herein, to select draft sets of tokens to be used by one or more neural networks to perform inferencing, and/or to perform other operations such as those described herein. The LLM(s) 130, the LLM functionality 124, the data augmentation functionality 126, the draft set selection functionality 128, the method 800, the method 900, the method 1000, at least a portion of the system 100, and/or other components described herein by used to implement robotics and/or a robotics application, such as those described herein. In at least one embodiment, the LLM(s) 130, the LLM functionality 124, the data augmentation functionality 126, the draft set selection functionality 128, and/or other functionality described herein, may be used to allow a robot to perceive and reason about its environment, communicate with one or more other robots and/or persons in an environment, and/or perform other operations, such as those described herein.

In some embodiments, the system and methods described herein may be deployed in an in-vehicle infotainment (IVI) system or in-cabin experience (IX) application. For example, the infotainment system within a vehicle (e.g., cars, trucks, drones, construction equipment, robots, semi-autonomous vehicles, or autonomous vehicles) may include one or more onboard processors (e.g., CPUs, GPUs, hardware-based deep learning accelerators (DLAs), hardware-based programmable vision accelerators (PVAs)—which may include one or more vector processing units (VPUs), direct memory access (DMA) systems, and/or pixel processing engines (PPEs), hardware-based optical flow accelerators (OFAs), SoCs, etc.) and memory and/or storage (e.g., for storing control algorithms, sensor data, and one or more machine learning models). and memory and/or storage (e.g., for storing entertainment content, navigation data, and user preferences). The system may use these processors to execute one or more machine learning models (e.g., language models) to enable features such as voice control, personalized media recommendations, dynamic navigation, and real-time communication with other services through network connectivity. The in-vehicle infotainment system may also use natural language processing (NLP) models to enable voice-based interaction. The one or more machine learning models may be stored locally or accessed through one or more APIs that connect to cloud services, enabling the system to process requests in real time or near real-time. By way of non-limiting examples, a vehicle (e.g., an autonomous vehicle, a semi-autonomous vehicle, and/or another type of vehicle), such as those described herein, may be used to implement the LLM(s) 130, the LLM functionality 124, the data augmentation functionality 126, the draft set selection functionality 128, and/or one or more other operations described herein. By way of additional non-limiting examples, at least a portion of one or more of the methods 800-1000 may be performed by a vehicle (e.g., an autonomous vehicle, a semi-autonomous vehicle, and/or another type of vehicle), such as those described herein. A vehicle (e.g., an autonomous vehicle, a semi-autonomous vehicle, and/or another type of vehicle), such as those described herein, may be used to implement at least one neural network, augment training data as described herein, use the augmented training data to train at least one neural network as described herein, to select draft sets of tokens to be used by one or more neural networks to perform inferencing, and/or to perform other operations such as those described herein. The LLM(s) 130, the LLM functionality 124, the data augmentation functionality 126, the draft set selection functionality 128, the method 800, the method 900, the method 1000, at least a portion of the system 100, and/or other components described herein by used to implement an IVI system, and/or an IX application, such as those described herein. In at least one embodiment, the LLM(s) 130, the LLM functionality 124, the data augmentation functionality 126, the draft set selection functionality 128, and/or other functionality described herein, may be used to enable features such as voice control, personalized media recommendations, dynamic navigation, real-time communication with other services through network connectivity, voice-based interaction, and/or perform other operations, such as those described herein.

Although examples may be described herein with respect to using machine learning models, such as neural networks, this is not intended to be limiting. For example, and without limitation, any of the various machine learning models and/or neural networks described herein may include any type of machine learning model, such as a machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoder neural networks, artificial neural networks (ANNs), convolutional neural networks (CNNs), recurrent neural networks (RNNs), perceptrons, Long/Short Term Memory (LSTM) networks, multi-layer perceptron (MLP) networks, deep stacking networks (DSNs), generative pre-training (GPT) models or networks, feed forward networks, radial basis function ANNs, self-organizing maps (SOMs), Kohonen maps, Hopfield networks, Boltzmann machine, deep belief neural networks, deconvolutional neural networks, generative adversarial networks (GANs), liquid state machines, modular neural networks, liquid state machines, sequence-to-sequence models, networks using transformer architectures, diffusion models (e.g., diffusion probabilistic models, score-based generative models, etc.), neural radiance field (NeRF) models, Gaussian splat models, Kolmogorov-Arnold networks (KANs), models with encoder-only architectures, models with decoder-only architectures, models with encoder-decoder architectures, generative machine learning models, language models, large language models (LLMs), vision language models (VLMs), multi-modal language models (MMLMs), etc.), and/or other types of machine learning models.

In some embodiments, one or more transformer engines (TEs) may be implemented. The transformer engine may use micro-tensor scaling to optimize performance and accuracy-such as to enable 16-bit floating point (FP16), 8-bit floating point (FP8), and/or 4-bit floating point (FP4) artificial intelligence processing. For example, the transformer engine may use 16-bit or 8-bit floating point precision and an 8-bit or 4-bit floating point data format combined with software algorithms for increasing AI performance and capabilities. By reducing math operations to 8-bits or 4-bits, the TE allows for training larger networks faster without compromising accuracy. For example, the TEs may include a library for accelerating transformer models on processing devices—such as GPUs—to provide better performance with lower memory utilization in both training and inference. When the TE is combined with other technologies, such as high-speed interconnects between nodes (e.g., using NVLink Switch) and tensor cores (which enable mixed-precision computing, such as microscaling precision support), server clusters may be more capable of training enormous networks at high speeds. As such, tensor core precisions of FP64, TF32, BF16, FP16, FP8, INT8, FP6, and FP4 may be supported, as well as CUDA core precisions of FP64, FP32, FP16, and BF16.

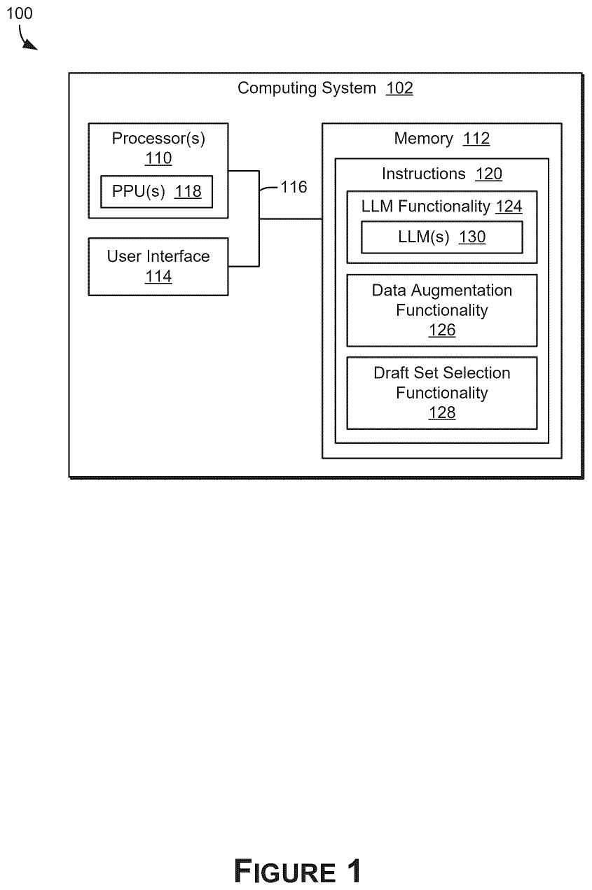

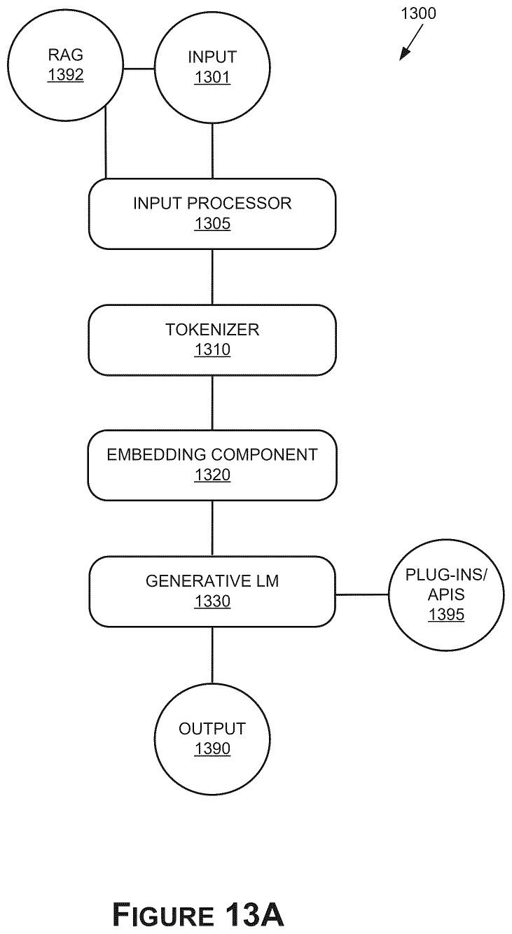

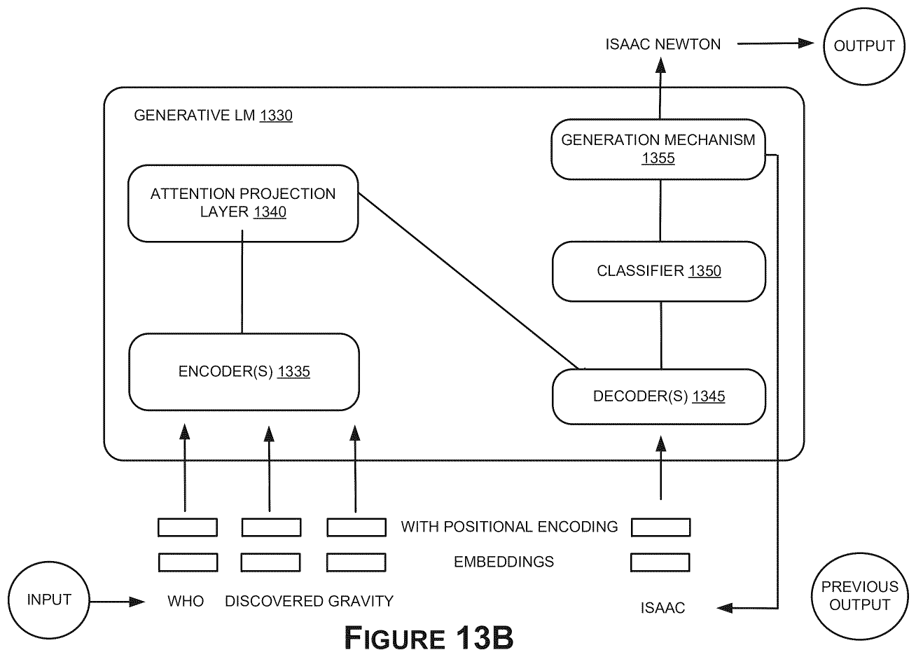

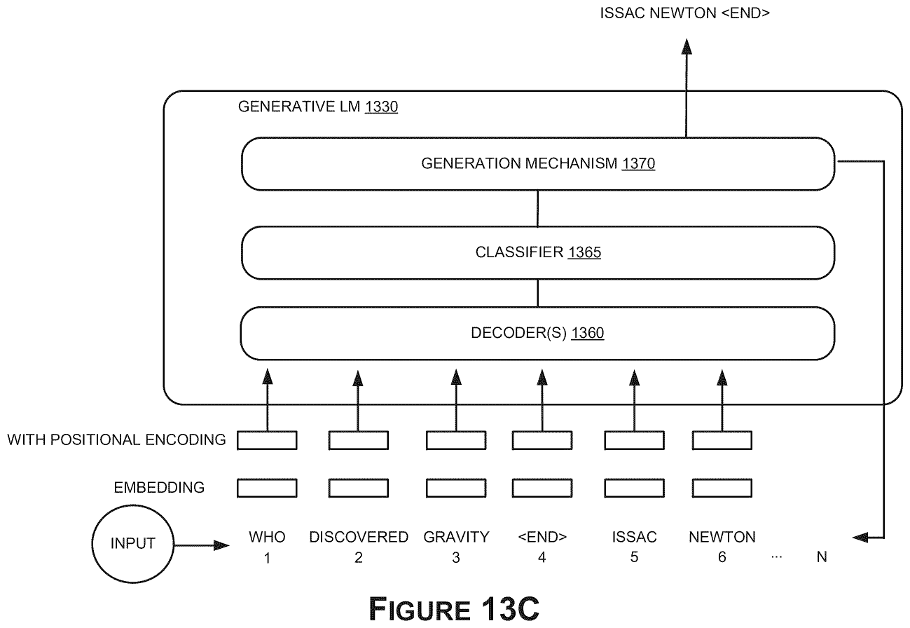

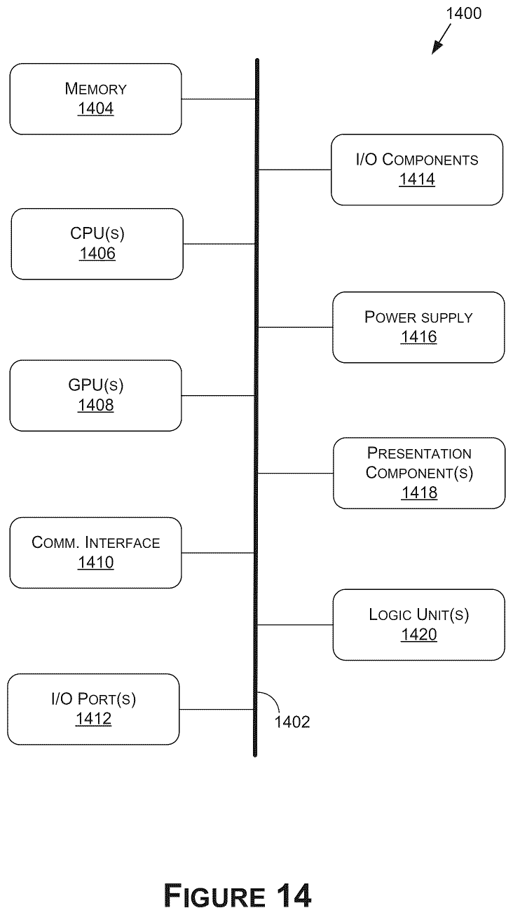

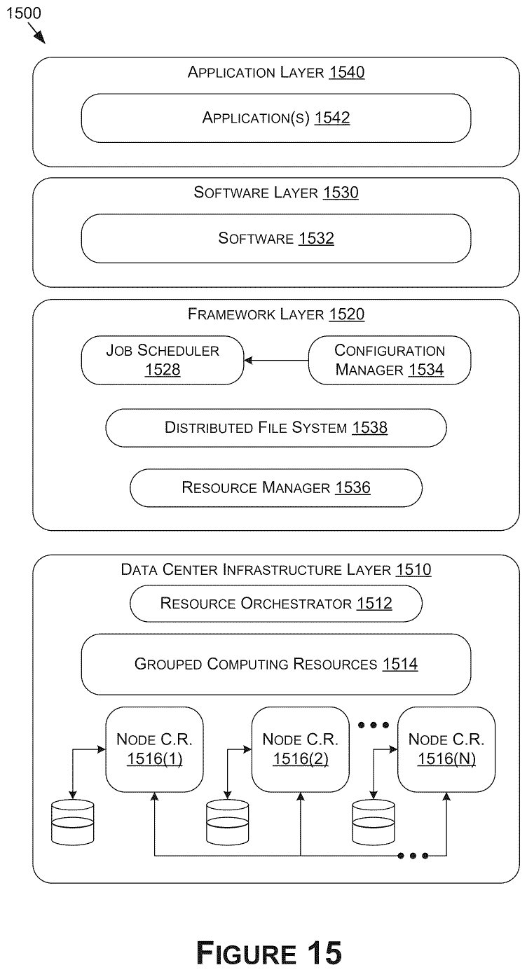

With reference to FIG. 1, FIG. 1 is a block diagram illustrating an example system 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out using one or more processor executing instructions stored in one or more memories. For example, in some embodiments, the system and methods described herein may be implemented using one or more generative language models (e.g., as described in FIGS. 13A-13C), one or more computing devices or components thereof (e.g., as described in FIG. 14), and/or one or more data centers or components thereof (e.g., as described in FIG. 15).

In at least one embodiment, the system 100 includes a computing system 102 that may include one or more processors 110, memory 112, and a user interface 114 connected to one another by one or more connections 116. The memory 112 (e.g., one or more non-transitory processor-readable medium) may store processor executable instructions 120 that when executed by the processor(s) 110 implement LLM functionality 124, data augmentation functionality 126, draft set selection functionality 128, and/or other functionality such as that described herein.

By way of additional non-limiting examples, the memory 112 (e.g., one or more non-transitory machine-readable medium) may be implemented, for example, using volatile memory (e.g., dynamic random-access memory (“DRAM”)) and/or nonvolatile memory (e.g., a hard drive, a solid-state device (“SSD”), and/or the like).

The processor(s) 110 may include one or more circuits that perform at least a portion of the instructions 120 stored in the memory 112. The processor(s) 110 may be implemented, for example, using a main central processing unit (“CPU”) complex, one or more microprocessors, one or more microcontrollers, one or more parallel processing units (“PPU(s)”) 118, one or more data processing units (“DPU(s)”), one or more arithmetic logic units (“ALU(s)”), and/or the like. The processor(s) 110 may include the PPU(s) 118, such as one or more graphics processing units (“GPU(s)”), one or more massively parallel GPU(s), and/or the like. In at least one embodiment, massively parallel GPU(s) refer to a collection of one or more GPUs, or any suitable processing units, which may be utilized to perform various processes in parallel.

The user interface 114 may include a display device (not shown) that a user may use to view information generated and/or displayed by the computing system 102. The user may use the user interface 114 to enter user input into the computing system 102. The user interface 114 may communicate (e.g., wirelessly) with a user device (e.g., a cellular telephone, a laptop computer, a tablet, and/or the like) and may receive user input from the user device. For example, the user interface 114 may receive values from the user device input by a user into the user device, and/or may provide information to the user device (e.g., for display by the user device).

The processor(s) 110, the user interface 114, and/or the memory 112 may communicate with one other over the connection(s) 116, which may be implemented using a bus, a Peripheral Component Interconnect Express (“PCIe”) connection (or bus), and/or the like.

The LLM (or VLM, MMLM, LAM, etc.) functionality 124 implements one or more neural networks, such as one or more LLMs 130 (or VLMs, MMLMs, LAMs, etc.), one or more Feedforward Neural Networks (FNN), one or more Convolutional Neural Networks (CNN), one or more Recurrent Neural Networks (RNN), one or more Long Short-Term Memory Networks (LSTM), one or more Gated Recurrent Units (GRU), one or more Radial Basis Function Networks (RBFN), one or more Autoencoders, one or more Generative Adversarial Networks (GANs), one or more Transformer Networks, one or more Graph Neural Networks (GNN), and/or one or more other types of neural network. In at least one embodiment, the LLM(s) 130 implement one or more generative language models, like generative language model 1330 (see FIG. 13A). The LLM functionality 124 may perform training with respect to the LLM(s) 130, which may perform inferencing with respect to input (e.g., one or more prompts), such as input 1301 illustrated in FIG. 13A. Referring to FIG. 1, the LLM(s) 130 may use speculative decoding, such as lookahead speculative decoding, during inferencing. Speculative decoding is a technique in which one or more drafters generate multiple potential continuations of an input sequence, referred to as draft sets of tokens, in parallel, rather than sequentially, the LLM performs inferencing with respect to each draft set to obtain output, and the LLM uses internal criteria to select the most likely or appropriate draft set based on the output. The drafter(s) may include a component of the LLM, one or more separate processes, such as one or more separate neural networks (e.g., one or more other LLMs). Each draft set of tokens may include one or more tokens.

The data augmentation functionality 126 implements a data augmentation technique that may be used to generate training data to be used by the LLM functionality 124 to train the LLM(s) 130. The LLM functionality 124 may use such augmented training data to fine-tune the LLM(s) 130, which may use speculative decoding (e.g., lookahead speculative decoding) during inferencing, such that the LLM(s) 130 achieve improved acceptance rates. Acceptance rate is a number of draft sets of tokens accepted per step or iteration of an LLM (e.g., one of the LLM(s) 130).

The draft set selection functionality 128 may be used at inference time to select those of the draft sets of tokens generated by the drafter(s) to be provided to the LLM(s) 130 to be used by the LLM(s) 130 to perform speculative decoding (e.g., lookahead speculative decoding).

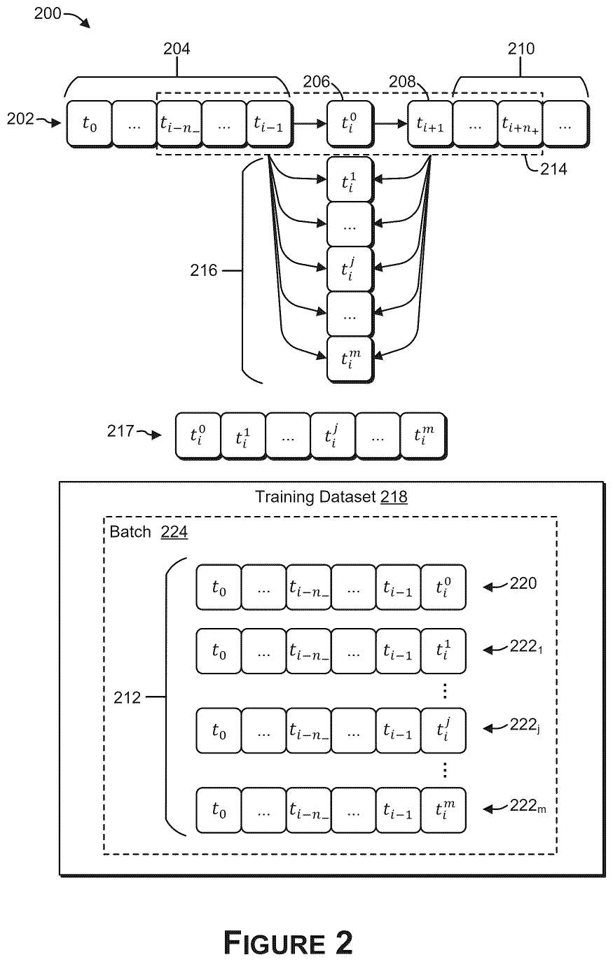

FIG. 2 is a block diagram illustrating an example data augmentation process 200, in accordance with some embodiments of the present disclosure. In at least one embodiment, the data augmentation process 200 is performed by the system 100. In at least one embodiment, the data augmentation process 200 is performed by the data augmentation functionality 126 (e.g., performed by the processor(s) 110). An LLM (e.g., one of the LLM(s) 130 implemented by the LLM functionality 124) predicts a next term or sequence of terms based upon a previous sequence of one or more ordered terms. The previous sequence terminates or ends at a last term, which will be referred to as a current term. The terms processed by the LLM have been tokenized (e.g., by the LLM functionality 124) using any method suitable for tokenizing input processed by an LLM, such as those described herein. Therefore, the current term corresponds to a current token. For example, a tokenizer, such as the tokenizer 1310 illustrated in FIG. 13A, may tokenize input processed by the LLM.

Referring to FIG. 2, a training sequence 202 of tokens is illustrated that includes one or more tokens 204 that precede a current token 206 (e.g., token

$${t}_{i}^{0} ) ,$$

which precedes a target (or golden) token 208 (e.g., ground truth token tᵢ₊₁) for which a prediction is to be generated. The training sequence 202 may represent any of the data included in the input 1301 illustrated in FIG. 13A. Referring to FIG. 2, the preceding token(s) 204 may include any tokens previously predicted for the training sequence 202 by the LLM, any tokens included in a prompt associated with the training sequence 202, and/or any tokens otherwise associated with the training sequence 202. The golden token 208 may be followed by one or more additional subsequent ground truth tokens 210.

To train an LLM (e.g., one of the LLM(s) 130 implemented by the LLM functionality 124), an input sequence 220 composed of tokens tᵢ, i∈{0, 1, . . . }, which includes the preceding token(s) 204 and the current token 206, may be provided to the LLM along with the golden token 208 to be predicted. The LLM may use the input sequence 220 to generate a predicted token (not shown) corresponding to the golden token 208. Tokens within the training sequence 202 may be sequentially predicted by treating each of the tokens as the current token 206 and using the LLM to predict a subsequent token (e.g., one of the ground truth token(s) 210).

Performance of the LLM (e.g., one of the LLM(s) 130) when performing inferencing may be improved (e.g., robustness and/or acceptance rate of tokens predicted by the LLM may be increased) by augmenting the single input sequence 220 with augmented training data 212 including one or more additional input sequences 222₁-222ₘ each associated with the golden token 208, and training the LLM using the augmented training data 212. The data augmentation functionality 126 may be used to generate the augmented training data 212, which may be included in a training dataset 218 that includes augmented training data generated by the data augmentation functionality 126 for different golden tokens of the training sequence 202, and/or augmented training data generated by the data augmentation functionality 126 for one or more different training sequences.

The data augmentation functionality 126 may select a number m of sets 216 of tokens from the training sequence 202 (ground truth) positioned within a window 214, and use these sets 216 of tokens to construct the additional input sequences 222₁-222ₘ. The number m may be a parameter value provided by a user. The window 214 may be centered at the current token 206, and may extend from a first token tᵢ₋ₙ_{_{−}} to a second token tᵢ₊ₙ_{₊}. Parameter values n₋ and n₊ may be provided by a user. The window 214 need not be centered at or symmetric about the current token 206. Further, windows of the same size need not be used for different current tokens and/or different training sequences.

The data augmentation functionality 126 may use the sets 216 of tokens to construct input sequences 222₁-222ₘ, each including the preceding token(s) 204 followed by one of the sets 216 of tokens. In at least one embodiment, to generate the input sequences 222₁-222ₘ, the data augmentation functionality 126 may use the sets 216 of tokens to enhance the input sequence 220. The data augmentation functionality 126 may construct a vector 217 that includes the current token 206 and the sets 216 of tokens, and may be expressed as

$${t}_{i}^{j} , j ∈ \{ 0 , … , m \} ,$$

where tᵢ⁰ is the current token 206 and

$${t}_{i}^{j} , j ∈ \{ 1 , … , m \}$$

are randomly sampled from within the window 214 (e.g., tᵢ, i∈{i−n₋, . . . , i+n₊}). Values of variables m, n₋, and n₊ may be values of hyperparameters of the LLM (e.g., one of the LLM(s) 130). The data augmentation functionality 126 may use the vector 217 to construct the input sequence 220 and the input sequences 222₁-222ₘ. Each of the input sequences 222₁-222ₘ is constructed by appending one of the sets 216 of tokens selected from within the window 214 to the preceding token(s) 204. Thus, the input sequences 222₁-222ₘ differ from the input sequences 220 because the input sequences 222₁-222ₘ each include one of the sets 216 of tokens in the position occupied by the current token 206 in the input sequence 220. The data augmentation functionality 126 may combine one or more of the input sequences 222₁-222ₘ and/or the input sequence 220 into at least one batch 224. In at least one embodiment, each input sequence of the batch 224 occupies a slot or position in the batch 224. During training, the LLM (e.g., one of the LLM(s) 130) may generate one or more next tokens for each input sequence in the batch 224, for example, in parallel.

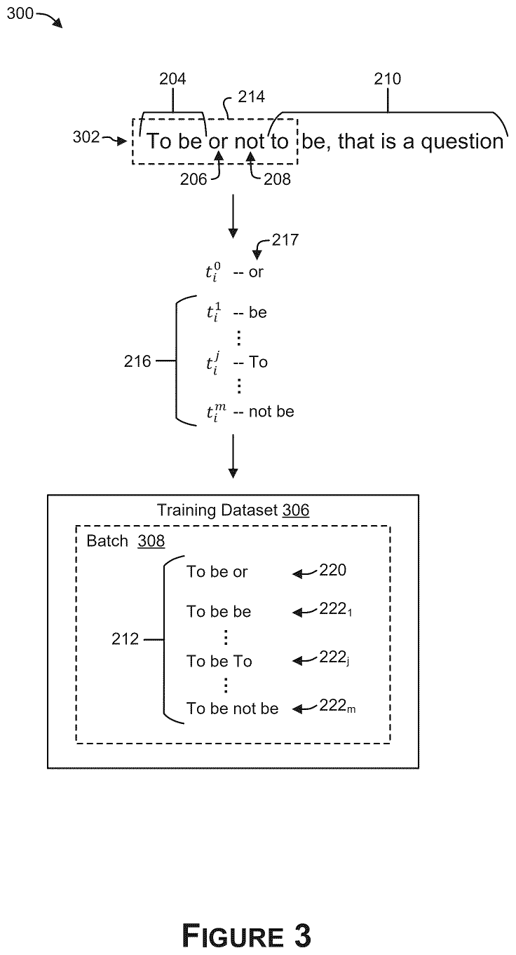

FIG. 3 is a block diagram illustrating an example 300 of input sequences 220 and 222₁-222ₘ generated for an example training or ground truth sequence 302, in accordance with some embodiments of the present disclosure. In the example illustrated in FIG. 3, the ground truth sequence 302 represents “To be or not to be, that is a question.” In this example, the current token 206 represents “or,” the preceding token(s) 204 represent “To be,” and the golden token 208 represents “not.” In this example, an LLM (e.g., one of the LLM(s) 130) may have previously predicted “To be or,” or it may have been provided in a prompt.

To generate the input sequences 222₁-222ₘ, the data augmentation functionality 126 (see FIG. 1) selects one or more tokens from the ground truth sequence 302 that appear within the window 214 (e.g., centered at the current token 206 (e.g., “or”)) and appends the selected token(s) to the preceding token(s) 204 (“To be”). For example, the data augmentation functionality 126 may select the number m of sets 216 of tokens from within the window 214, and construct one of the input sequences 222₁-222ₘ for each of the sets 216. The data augmentation functionality 126 may construct the vector 217 that includes the current token 206 and the sets 216 of tokens and the data augmentation functionality 126 and/or the LLM functionality 124 may use the vector 217 to construct the input sequences 220 and 222₁-222ₘ. If, for example, the window 214 has a size of five, the data augmentation functionality 126 will select one or more of the following words: “To,” “be,” “or,” “not,” or “to” and use the selection to construct one of the sets 216 of tokens. The data augmentation functionality 126 may include the input sequence 220 (which includes the current token 206 (e.g., “or”) along with the input sequences 222₁-222ₘ in a training dataset 306. If the term “be” is selected, the data augmentation functionality 126 may construct an input sequence “To be be.” By way of another non-limiting example, the terms “or” and “to” may be selected to construct an input sequence “To be or to.” Then, each of the input sequences 220 and 222₁-222ₘ are associated (or labeled) with the correct next token, which is the golden token 208 (e.g., “not”), and added to the training dataset 306, which is used to train the LLM (e.g., one of the LLM(s) 130). The input sequences 220 and 222₁-222ₘ each associated (or labeled) with the golden token 208 may be added to a batch 308 and the batch 308 may be added to the training dataset 306. As mentioned above, the LLM (e.g., one of the LLM(s) 130) may process the input sequences 220 and 222₁-222ₘ included in the batch 224 in parallel.

The input sequences 222₁-222ₘ may augment the input sequence 220 and improve inference results produced by the LLM (e.g., one of the LLM(s) 130). For example, the input sequences 222₁-222ₘ may help improve the acceptance rate of results produced by the LLM when the LLM performs one or more lookahead algorithms.

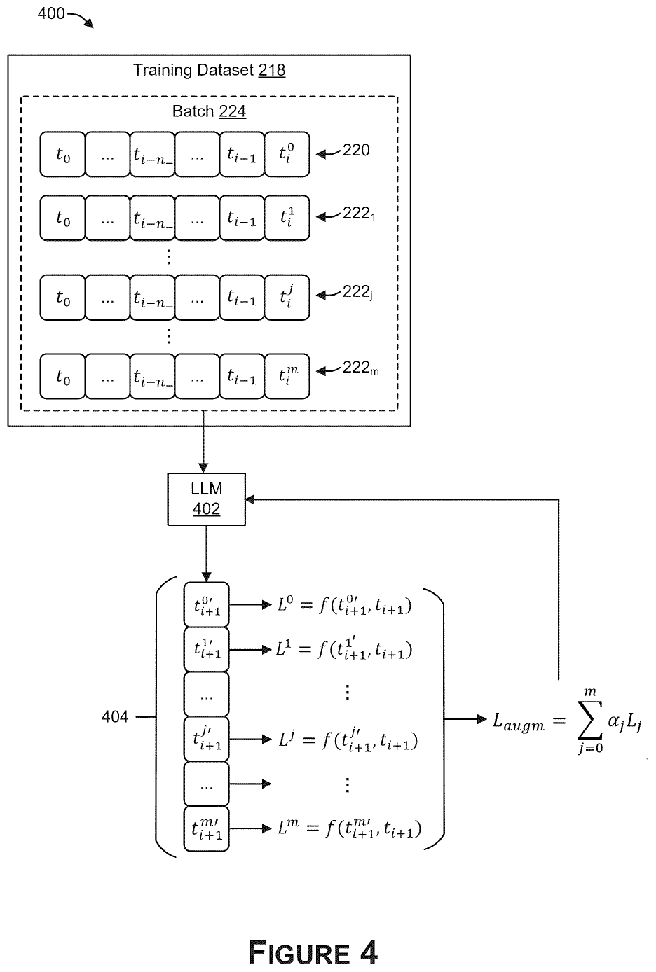

FIG. 4 is a block diagram illustrating a training process 400 of using augmented data generated using the data augmentation process 200 of FIG. 2 to train an LLM 402, in accordance with some embodiments of the present disclosure. Referring to FIG. 4, the LLM 402 may output a set or output vector 404 of predicted tokens according to

$${t}_{i + 1}^{j ′} = {π}_{θ} ( {t}_{0} , … , {t}_{i - 1} , {t}_{i}^{j} ) .$$

The variable θ represents parameters of the LLM, such as weights, biases, learning rate, activation functions, batch size, sequence length, layer dimensions, layer quantity, and/or others. The output vector 404 of predicted tokens may include a token corresponding to each of the sets 216 of tokens in the vector 217 and corresponding to each of the input sequences 220 and 222₁-222ₘ.

The LLM functionality 124 may calculate a loss value for each of the predicted tokens in the output vector 404 using a loss function

$${L}^{j} = f ( {t}_{i + 1}^{j ′} , {t}_{i + 1} ) ,$$

which compares the predicted tokens to ground truth tokens of the training sequence 202. A loss value

$$( e . g . , L = f ( {t}_{i + 1}^{′} , {t}_{i + 1} ) )$$

may be computed as a function of this output, and the ground truth token tᵢ₊₁ (e.g., the golden token 208), and the loss value may be used (e.g., aggregated with different loss values calculated using different current tokens, and/or input sequences) to calculate gradients to be used to update the parameters θ of the LLM.

The LLM functionality 124 may calculate a loss value for the output vector 404 using a vector-level loss function,

$${L}_{augm} = {\sum }_{j = 0}^{m} {α}_{j} {L}_{j} ,$$

that aggregates the loss values L^{j} calculated for the predicted tokens in the output vector 404. In the vector-level loss function, a variable αⱼ may represent a series weight parameter values that may be provided to the LLM (e.g., by a user) as a hyperparameter values, such as aⱼ<1 for j>0. The vector-level loss function, L_{augm} may be used to compute gradients to be used to update the LLM parameters θ (e.g., weights) accordingly. By constructing the input sequences 222₁-222ₘ and using them to predict a token (e.g., the golden token 208) during training, training is improved causing an acceptance rate of the neural network (e.g., LLM) to increase without altering a structure of the neural network.

Training the LLM 402 using only the single input sequence 220, which includes the preceding token(s) 204 and the current token 206, would constrain the LLM 402 to using only a number (e.g., quantity) of tokens preceding the golden token 208 when generating a prediction, which may negatively impact the acceptance rate of predicted tokens at inference time. Furthermore, during training, only one subsequent token may be predicted by the LLM 402 during each step or iteration, which, in combination with the constraints imposed on the acceptance rate, may cause prediction of a sequence of tokens to be undesirably slow. However, by using the input sequences 220 and 222₁-222ₘ to train the LLM 402, the LLM 402 may predict more than one token per step or training iteration. For example, each predicted token corresponding to the batch 224 of the input sequences 220 and 222₁-222ₘ may be tokens of different lengths within a given window of tokens, thereby allowing more than one token of the subsequent ground truth token(s) 210 to be predicted within an iteration. Furthermore, more than one of the subsequent ground truth token(s) 210 may be predicted in parallel.

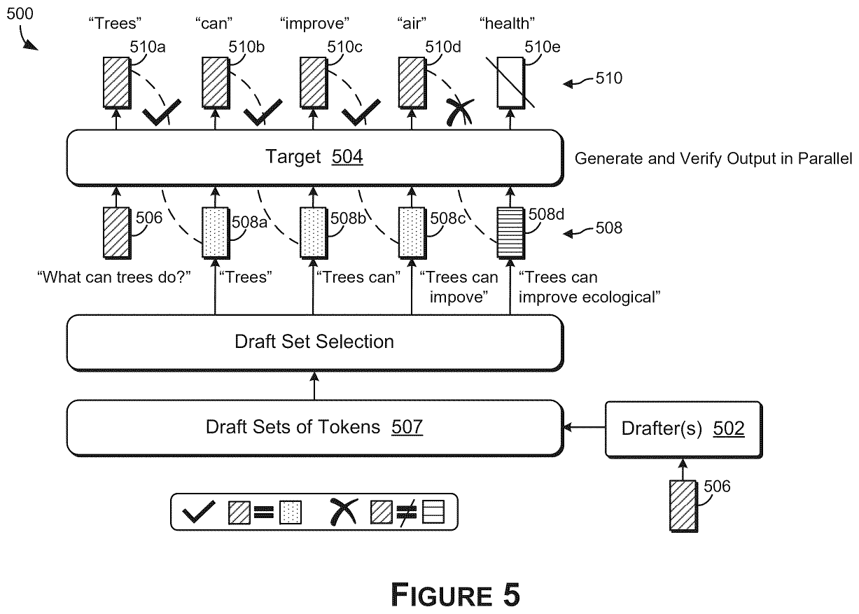

FIG. 5 illustrates an example process 500 of using lookahead speculative decoding to predict one or more next tokens, in accordance with some embodiments of the present disclosure. As shown in FIG. 5, the process 500 performs speculative decoding, and may be performed at least in part by one or more drafters 502, the draft set selection functionality 128 (e.g., performed by the processor(s) 110), and a target 504 (e.g., the LLM(s) 130). Lookahead speculative decoding may be performed at one or more computing devices (e.g., the computing system 102) by one or more neural networks, such as an LLM (e.g., one of the LLM(s) 130). In at least one embodiment, the drafter(s) 502 and the target 504 may be implemented at one or more layers of the LLM.

The drafter(s) 502 may perform different algorithms and/or one or more of the drafter(s) 502 may perform different branches of a common algorithm. The drafter(s) 502 may be, for example, a component or mechanism of lookahead speculative decoding that receives a prompt, which may include an input sequence 506 of one or more tokens (e.g., representing one or more terms). In response to receiving the input sequence 506, the drafter(s) 502 may generate (e.g., draft) preliminary, speculative, candidate, or draft sets 507 of tokens corresponding to the input sequence 506. In at least one embodiment, the drafter(s) 502 may generate the draft sets 507 of tokens as multiple potential continuations of the input sequence 506. At least a portion of the draft sets 507 of tokens may be generated by the drafter(s) 502 concurrently, e.g., in parallel.

Each of the draft sets 507 of tokens includes one or more tokens each at a different position of the draft set. For example, if a draft set represents the sequence “Hello World,” the draft set includes a first token representing “Hello” at a first position, and a second token representing “World” at a second position. Each of the draft sets 507 of tokens may be characterized as having a number of positions, referred to as a length. For example, the draft set representing the sequence “Hello World” has a length of two, meaning the draft set includes two tokens. The position of a token may be referred to as a number of the token or the token's number within the draft set. The length of the draft sets 507 of tokens provided to the target 504 can affect the efficiency of the target 504. For example, if a longer draft set is accepted, the target 504 can skip at least some iterations. For example, if the draft set “Hello World” is accepted, the target 504 need not perform an iteration to select the token “World” after the token “Hello” is selected. Instead, the target 504 selects both of these tokens at the same time. Unfortunately, causing the target 504 to process longer draft set that do not result in acceptances, wastes processing resources.

The drafter(s) 502 provide(s) the draft sets 507 of tokens to the draft set selection functionality 128 (e.g., performed by the processor(s) 110), which selects draft sets 508 of tokens to be input into the target 504 (e.g., as a batch). For example, the draft set selection functionality 128 may schedule or plan input into the target 504. By way of a non-limiting example, the input provided to the target 504 by the draft set selection functionality 128 may be characterized as include a plurality of slots, which may be arranged in a series. The draft set selection functionality 128 may schedule the input to the target 504 by filling each slot with one of the selected draft sets 508 of tokens to be input into and processed by the target 504 (e.g., as a batch). In at least one embodiment, the draft set selection functionality 128 schedules input to the target 504 (e.g., a neural network, LLM, etc.) using historical data (e.g., batch execution times, and number of draft sets of tokens accepted that include a token in a particular token position). The draft set selection functionality 128 may schedule the input to the target 504 in a manner that improves the efficiency of the target 504. For example, the draft set selection functionality 128 may dynamically balance the draft set lengths according to their profits during inferencing to improve inferencing speed.

The draft set selection functionality 128 (e.g., performed by the processor(s) 110) may estimate marginal draft set costs (or execution time) associated with performing inferencing if the length of the draft sets of tokens is increased by another token. For example, each batch includes draft sets of tokens (e.g., representing one or more terms or words) that include up to a number (N) of tokens (e.g., representing individual words or other terms in the draft set). For a particular number (N) of tokens, the draft set selection functionality 128 may estimate a marginal draft set cost by averaging execution times required by previously processed batches of draft sets of tokens including up to that number (N) of tokens, and subtracting an average execution time required by previously processed batches of draft sets of tokens including up to one fewer (N-1) tokens. In at least one embodiment, one or more computing devices record a total number of tokens (N) and a total inference time (T_{N}) when a batch of requests are passed through a LLM inference engine, such as a LLM inference engine 602 of FIG. 2. An average total inference is determined according to

$${\tilde{T}}_{N} = \frac{1}{{m}_{B}} \sum {T}_{N} .$$

The variable m_{B} is a number of tokens in all of the batches of draft sets of tokens including up to the number (N) of tokens. A marginal cost for an N^{th} token may be computed as Marginal_Cost_{N}=\tilde{T}_{N}−\tilde{T}_{N-1}. By way of a non-limiting example, Table A below shows an example of a calculation of marginal draft set costs associated with adding an N^{th} token to draft sets of tokens:

TABLE A

| Max Number (N) of | | | | | | |
|---|---|---|---|---|---|---|
| Tokens In Draft Sets | 1 | 2 | 3 | 4 | 5 | 6 |
| Average Processing | 1.80 | 3.80 | 5.90 | 8.00 | 10.20 | 12.60 |
| Times For Draft Sets | | | | | | |
| of Tokens in Batches | | | | | | |
| Including Up To N | | | | | | |
| Tokens | | | | | | |
| Marginal Cost of | 1.80 | 2.00 | 2.10 | 2.10 | 2.20 | 2.40 |
| Nth Token | | | | | | |

The draft set selection functionality 128 (e.g., performed by the processor(s) 110) may calculate marginal draft set profit for each token position based on a token acceptance rate. For example, using historic data, the draft set selection functionality 128 may determine how many draft sets of tokens were accepted that include a token at each token position (e.g., second line of Table B below), and calculate the marginal draft set profit (third line of Table B below). For example, if a draft set that includes three tokens is accepted, the draft set selection functionality 128 may increase the number of draft sets of tokens accepted for each of the first, second, and third token positions by one. The draft set selection functionality 128 may calculate the marginal draft set profit for each token position by dividing a number of draft sets of tokens accepted (that include a token at that position) by a number of times the number of accepted draft sets of tokens was updated. The draft set selection functionality 128 may perform such updates at intervals. By way of a non-limiting example, referring to Table B below, if a total of three draft sets of tokens were accepted, and the three draft sets of tokens included one token, two tokens, and three tokens, respectively, three tokens in the first position, two tokens in the second position, one token in the third position, and no tokens in other positions were accepted (see the second row of Table B). Continuing this example, if the draft set selection functionality 128 updated the number of accepted draft sets of tokens three times (e.g., at three intervals), the marginal draft set profit for tokens at the first position is one (number of accepted draft sets of tokens divided by number of updates=3/3=1), the marginal draft set profit for tokens at the second position is 0.67 (⅔=0.67), the marginal draft set profit for tokens at the third position is 0.33 (⅓=0.33), and the marginal draft set profits for tokens at other positions are zero.

TABLE B

| Token Position | 1 | 2 | 3 | 4 | 5 | 6 |
|---|---|---|---|---|---|---|
| Number Draft Sets | 3 | 2 | 1 | 0 | 0 | 0 |
| of Tokens Accepted | | | | | | |
| Marginal Profit | 1.00 | 0.67 | 0.33 | 0.00 | 0.00 | 0.00 |
| Marginal Cost of | 1.80 | 2.00 | 2.10 | 2.10 | 2.20 | 2.40 |
| Nth Token | | | | | | |
| Ratio | 0.56 | 0.33 | 0.16 | 0.00 | 0.00 | 0.00 |

In at least one embodiment, profiling a marginal profit of draft sets of tokens by the draft set selection functionality 128 includes calculating a marginal draft set profit for each token position based on a token acceptance rate. The profiling allows the draft set selection functionality 128 to determine how many and which draft sets of tokens are to be provided to an LLM. For example, the draft set selection functionality 128 may use a most recent golden token, draft sets of tokens, newly generated tokens, and relevant parameters to select which draft sets of tokens are to be input into the LLM. In at least one embodiment, the draft set selection functionality 128 may use one or more histograms to determine the second row of Table B above. For example, if multiple sources of speculative decoding algorithms (e.g., the drafter(s) 502 include multiple drafters) are used, a histogram may be used for each source. As an example, the sources may be different algorithms or different branches of one algorithm. The draft set selection functionality 128 may record each histogram according to the following pseudocode: histogram[i]+=i<=accepted_tokens. This pseudocode increments the i-th element of histogram by 1 if i is less than or equal to accepted_tokens, and by 0 otherwise. The variable accepted_tokens stores the length of an accepted draft set of one or more tokens. The draft set selection functionality 128 may use the histogram(s) to obtain a marginal profit of an i^{th} token (e.g., the third row of Table B above) using the following pseudocode: MarginalProfit[i]=histogram[i]/total_steps. The i^{th} token may be a virtual index in a draft set rather than a physical index of the draft set. For example, when an extra n^{th} token is added to the algorithm, the n^{th} token may be inserted in any position in a sequence defined by a draft set, and is not necessarily a last token in the sequence.

For each token position, the draft set selection functionality 128 (e.g., performed by the processor(s) 110) may obtain a ratio by dividing the marginal draft set profit associated with the token position by the marginal draft set cost associated with the token position. In the example illustrated in Table B, the ratio (e.g., last row of Table B) is 0.56 for the token in first position (1.00/1.80=0.56), the ratio is 0.33 for the token in second position (0.67/2.00=0.33), the ratio is 0.16 for the token in third position (0.33/2.10=0.16), and the ratio is zero for all other token positions.

At inference time, the draft set selection functionality 128 (e.g., performed by the processor(s) 110) may determine which of the draft sets 507 of tokens (e.g., included in a batch) generated by the drafter(s) 502 are to be processed by the target 504. For example, the draft set selection functionality 128 may look up the marginal draft set profit and ratio calculated using historical data for each of the draft sets 507 of tokens. For a particular draft set of one or more tokens, the draft set selection functionality 128 selects the marginal draft set profit and ratio associated with the highest number token in a draft set. For example, the draft set selection functionality 128 may use the marginal draft set profit (e.g., 0.33 in Table B) and ratio (e.g., 0.16 in Table B) associated with the third position for a draft set that includes three tokens. Then, the draft set selection functionality 128 may select one of the draft sets 507 of tokens associated with a largest marginal draft set profit, and allocate a slot to the selected draft set, which means that the target 504 will process the selected draft set. Next, the draft set selection functionality 128 may compare the ratio associated with the selected draft set to a waterline or threshold value. If the ratio is less than the threshold value, the acceptance rate is not high enough to justify the cost (time) of processing additional draft sets of tokens, which are associated with the same or a lower marginal draft set profit. When this is the case, the draft set selection functionality 128 may stop allocating slots to any remaining draft sets of tokens in the batch. On the other hand, if the ratio is equal to or exceeds the threshold value, the draft set selection functionality 128 may select another draft set associated with a next largest marginal draft set profit, and allocate a slot to the selected draft set, which means that the target 504 will process that draft set. Then, the draft set selection functionality 128 may use the ratio to decide whether to continue allocating slots for additional draft sets of tokens. The draft set selection functionality 128 may fine tune allocation according to memory and/or computational budgets by adjusting the threshold value. The threshold value may be provided by a user and/or determined at least in part by one or more automated processes. By way of a non-limiting example, the draft set selection functionality 128 may perform a process in accordance with the following pseudocode to determine which of the draft sets 507 of tokens (e.g., included in a batch) generated by the drafter(s) 502 are to be processed by the target 504:

```
for i=0; i < N−1; i++
  select the largest marginal profit P from requests and
allocate 1 token for the request.
  if P/MarginCostᵢ < waterline
    break
  endif
endor
```

The target 504 may be, for example, a component or mechanism of lookahead speculative decoding that receives and evaluates the selected draft sets 508 of tokens generated by the drafter(s) 502. The target 504 may be, for example, one or the LLM(s) 130 implemented by the LLM functionality 124. The target 504 generates predictions 510 in parallel based at least in part on the selected draft sets 508 of tokens, and verifies or classifies each of the predictions 510 as being correct or incorrect. The selected draft sets 508 of tokens shown in FIG. 5 include accepted draft sets 508 a-508c of tokens that represent correct predictions and at least one draft set 508d that was not accepted and is an incorrect prediction.

In at least one embodiment, the target 504 receives the input sequence 506 and the selected draft sets 508 of tokens and verifies the draft sets 508 of tokens in parallel. As an example, the target 504 may assess the draft sets 508 of tokens to determine how well the draft sets 508 of tokens align with the input sequence 506 (e.g., according to predetermined criteria). The target 504 may compare the draft sets 508 of tokens with the predictions 510 output by the target 504 based on the draft sets 508 of tokens to identify which of the predictions 510 are correct (e.g., are continuations of the input sequence 506), as indicated by a checkmark, and which are incorrect (e.g., are not continuations of the input sequence 506), as indicated by an “x.”

The draft sets 508 of tokens are each a possible continuation of the input sequence 506. The target 504 may accept one or more of the draft sets 508 of tokens based on internal criteria of the target 504, which may have been derived at least in part from training data (e.g., the training dataset 218). The internal criteria may cause the target 504 to accept draft sets of tokens based on a likelihood or fluency of each continuation according to patterns the target 504 learned from the training data (e.g., the training dataset 218). For example, if the prediction 510a generated by the target 504 for the input sequence 506 (e.g., “What can trees do?”) is “Trees” and the draft set 508a is “Trees,” the internal criteria of the target 504 will cause the target 504 to accept the draft set 508a (or consider the draft set 508a to be correct). In this example, an exact match occurred between the prediction 510a and the draft set 508a but instead, the prediction 510a and the draft set 508a may be similar but not identical in which case the internal criteria of the target 504 will determine whether the target 504 accepts the draft set 508a. In this example, only one of the draft sets 508 of tokens includes a single token (“Trees”); however, the draft sets 508 of tokens may include additional draft sets of tokens that include a single token which may each be accepted or not accepted based upon the internal criteria of the target 504.

Because the target 504 accepted the draft set 508a, the prediction 510b generated by the target 504 for the draft set 508a is compared to the draft set 508b. For example, if the prediction 510b generated by the target 504 for the draft set 508a represents “can” and the draft set 508b represents “Trees can,” the internal criteria of the target 504 will cause the target 504 to accept the draft set 508b. Again, the internal criteria of the target 504 may be used to determine whether or not to accept any draft sets of tokens that do not match the prediction 510b exactly, and/or whether to accept any other draft sets of tokens that also include two tokens. Continuing this example, if the prediction 510c generated by the target 504 for the draft set 508b is “improve” and the draft set 508c is “Trees can improve,” the internal criteria of the target 504 will cause the target 504 to accept the draft set 508c. Again, the internal criteria of the target 504 may be used to determine whether or not to accept any draft sets of tokens that do not match the prediction 510c exactly, and/or whether to accept any other draft sets of tokens that also include three tokens. This process continues until a bifurcation point is reached or all of the draft sets 508 of tokens have been evaluated by the target 504. For example, if the prediction 510d generated by the target 504 for the draft set 508c is “air” and the draft set 508d is “Trees can improve ecological,” the target 504 may, according to its internal criteria, not accept the draft set 508d (e.g., consider it to be incorrect). In this example, the draft set 508c is a last accepted draft set before a bifurcation point at which output of the target 504 branches (e.g., “Trees can improve air quality” versus “Trees can improve ecological health”). At this point, the draft set 508d may be discarded along with any subsequent tokens that continue from the draft set 508d along the same branch. If the draft sets 508 of tokens include a draft set that represents “Trees can improve air,” that draft set may be accepted and the verification process continued until a bifurcation point is reached or all of the draft sets 508 of tokens have been evaluated by the target 504. If the target 504 has accepted more than one draft set, the target 504 may use its internal criteria to select one of these draft sets of tokens.

Until stopping criteria is satisfied, the target 504 may use output of the current iteration (e.g., the selected draft set and, in at least one embodiment, the prediction generated by target 504 for the selected draft set) to construct a new input sequence that includes the input sequence 506 concatenated with the output of the current iteration. In the example illustrated in FIG. 5, the target 504 may determine that, based on the evaluations, that the draft set 508c and/or the prediction 510d is the output of the present iteration of the target 504. Thus, in this example, the target 504 may use lookahead speculative decoding to select multiple tokens (e.g., representing “Trees,” “can,” “improve,” and, in at least one embodiment, “air”) in one iteration and supply the new input sequence to the target 504 in a next iteration to be used generate new output. For example, the new input sequence may represent “What can trees do? Trees can improve,” or “What can trees do? Trees can improve air.” In at least one embodiment, results of the verification performed by the target 504 may be used to update one or more of the drafter(s) 502.

Referring to FIG. 2, training an LLM (e.g., the target 504) using only the single input sequence 220, which includes the preceding token(s) 204 and the current token 206, constrains the LLM to using only a number (e.g., quantity) of tokens preceding the golden token 208 when generating a prediction, which may negatively impact the acceptance rate of predicted tokens at inference time. Therefore, augmented data generated by the data augmentation functionality 126 (e.g., performed by the processor(s) 110) may be used to train the LLM (e.g., the target 504) to improve its token acceptance rate.

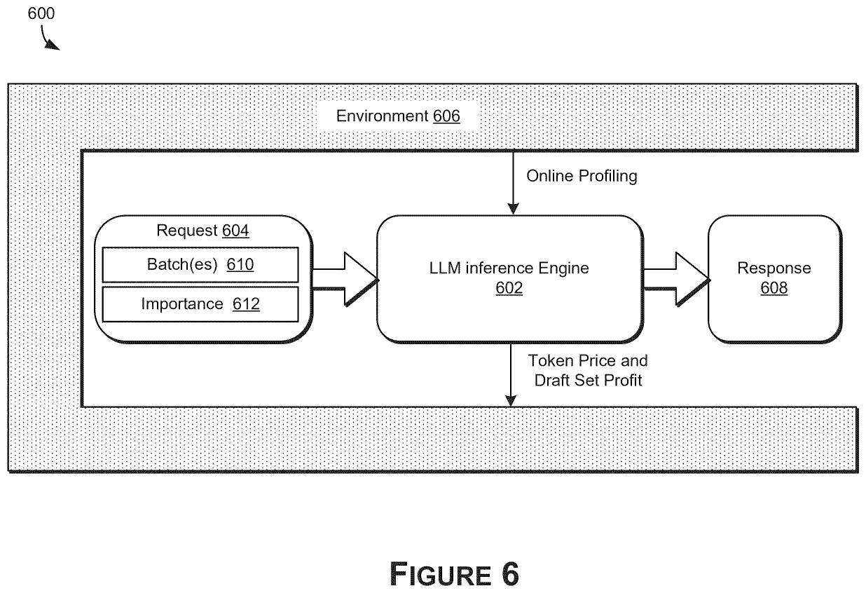

FIG. 6 is a block diagram illustrating a workflow 600 that may used to collect information related to speculative decoding, in accordance with some embodiments of the present disclosure. The workflow 600 may be implemented at one or more computing devices (such as those described with reference to FIG. 1 and/or FIG. 14), at a data center as described below in connection with FIG. 15, using one or more neural networks, as described in FIGS. 13A-13C. In at least one embodiment, generation of a result or response 608 may be performed at an LLM inference engine 602, which may be trained to perform lookahead speculative decoding as described herein. The LLM inference engine 602 may include or be a component of a LLM (e.g., one of the LLM(s) 130) to perform lookahead speculative decoding to predict text in response to receiving a request 604 including a prompt or input sequence (e.g., a sequence of one or more tokens included in or provided along with at least one batch 610 of draft sets of tokens). The LLM may be trained, in at least one embodiment, to perform language processing tasks.

The request 604 may include or identify at least one batch 610 of draft sets of tokens, and may indicate an importance 612 of the request, each of the batch(es), and/or each of the draft sets of tokens. The importance 612, for example, may indicate a priority of the request 604, relative to other requests, and/or may denote an urgency or relevancy of one of the batch(es) 610 with respect to one or more other batches. In at least one embodiment, the importance 612 may be indicated by a weight, e.g., a weight value. The request 604 may include instructions, guidelines, or constraints to be applied to inferences generated by the LLM inference engine 602, an objective of the request 604, parameters for assessing the draft sets of tokens to be used by the LLM inference engine 602 to perform inference, and/or instructions for a feedback mechanism to update the LLM inference engine 602 based on evaluation of the draft sets of tokens. In at least one embodiment, the feedback mechanism may be included in an environment 606 implementing the workflow 600.

As described herein, the draft set selection functionality 128 uses information (e.g., historical data) to determine a ratio (e.g., the last row of Table B) based at least in part on a marginal draft set costs associated with adding an Nth token (e.g., the last row of Table A and the fourth row of Table B), and marginal draft set profit for each token position (e.g., the third row of Table B). This information may include a total number of tokens (N) in batch(es) included in and/or identified by one or more requests, a total inference time (T_{N}) for each of the batch(es) when it is passed through the LLM inference engine 602, and/or acceptance rates for the LLM inference engine 602 (e.g., at each iteration). For example, with respect to FIG. 6, this historical data may include a total number of tokens (N) in each of the batch(es) 610 of the request 604, and a total inference time (T_{N}) for each of the batch(es) 610 when it is passed through the LLM inference engine 602.

As an example, the environment 606 may include one or more of a computational environment, such as hardware and software used to perform the LLM inference engine 602, an operational context under which lookahead speculative decoding may be performed, and/or a testing environment for testing lookahead speculative decoding strategies. The LLM inference engine 602 may use the request 604, along with information collected by online profiling obtained from the environment 606 (e.g., collecting data regarding online activities) to generate a response 608. One or more computing devices operating in the environment 606 (e.g., the computing system 102) may profile or otherwise collect information related to inference processes performed by the LLM inference engine 602 and/or one or more other LLM inference engines operating in the environment 606 to be used by the draft set selection functionality 128. Such LLM inference engine(s) may be trained to generate text using lookahead speculative decoding, and/or trained on augmented data, as described herein, for example, in conjunction with FIGS. 1-10. The draft set selection functionality 128 may profile and/or otherwise collect the information. The profiling or information collection may include collecting information to calculate a ratio (e.g., the last row of Table B), a marginal draft set costs associated with adding an Nth token (e.g., the last row of Table A and the fourth row of Table B), and/or marginal draft set profit for each token position (e.g., the third row of Table B). The computing device(s) operating in the environment 606 may store a total number of tokens (N) in batch(es) included in and/or identified by one or more requests, a total inference time (T_{N}) for each of the batch(es) when it is passed through the LLM inference engine 602, and/or acceptance rates for the LLM inference engine 602 (e.g., at each iteration). The computing device(s) operating in the environment 606 may store the acceptance rates in one or more histograms as described herein, and marginal profit of an i^{th} token (e.g., the third row of Table B above) may be calculated (e.g., by the computing device(s) operating in the environment 606, and/or the draft set selection functionality 128) using a process described with respect to pseudocode provided herein.

As described above, lookahead speculative decoding may be implemented by a LLM (e.g., the LLM inference engine 602) to obtain text predictions generated based on one or more draft sets of tokens (e.g., included in or identified by the batch(es) 610) input to the LLM. In at least one embodiment, the LLM inference engine 602 may generate the draft sets of tokens and/or the draft sets of tokens may be generated by another process (e.g., one or more neural networks) for subsequent inferencing by the LLM inference engine 602 or one or more other LLM inference engines. The LLM(s) performing such inferencing may have been trained according to a training process that causes an acceptance rate of the LLM(s) to be increased. In at least one embodiment, the training process uses training data augmented (e.g., using data augmentation process 200) to increase a number of tokens accepted per step (e.g., inference cycle or inference iteration), where the number of tokens accepted per step may also be referred to as an acceptance rate.

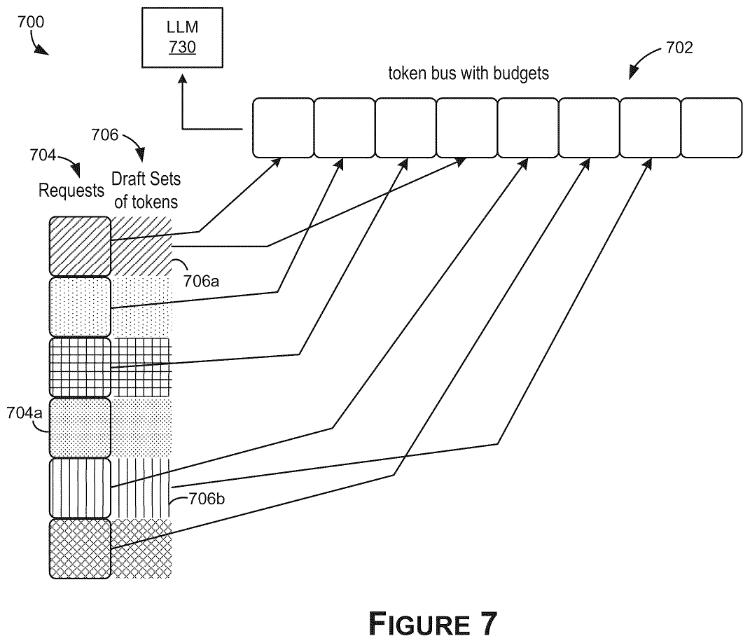

FIG. 7 is a block diagram illustrating a process 700 of allocating tokens of a draft set, sequence, or batch to slots to be input into an LLM 730, in accordance with some embodiments of the present disclosure. FIG. 7 depicts a token bus 702 that accounts for costs of tokens to be input to the LLM 730 (e.g., one of the LLM(s) 130). For example, each slot of the token bus 702 may be associated with an allocation budget (e.g., use of computational resources). The token bus 702 includes a plurality of draft set positions or slots depicted as a row of boxes. FIG. 7 depicts a plurality of requests 704 as a column of shaded boxes with solid outlines and a plurality of draft sets 706 of tokens as a column of shaded boxes without solid outlines. In at least one embodiment, the plurality of requests 704 correspond to user prompts that include tokens. The plurality of draft sets 706 of tokens may be draft sets of tokens generated as described above.

In at least one embodiment, as depicted in FIG. 7, the LLM functionality 124 and/or the draft set selection functionality 128 may allocate a slot of the plurality of slots of the token bus 702 to each of the plurality of requests 704, except in instances where an importance (e.g., the importance 612) of the request is indicated, for example, by a user, to be low. At least one token is thereby input to the LLM 730 for text prediction for each request, which allows progress to be made for each of the plurality of requests 704. For some of the plurality of requests 704, an importance of the corresponding request may be lower than any of the other requests. In at least one embodiment, the importance (e.g., the importance 612) may be indicated based on user input. For example, a fourth request 704a of the plurality of requests 704 is indicated by a user to be of low importance according to a weight assigned thereto by the user. As a result, the fourth request 704a, is not allocated to a slot of the token bus 702.

The LLM functionality 124 and/or the draft set selection functionality 128 may allocate a slot of the token bus 702 to one or more draft sets of tokens of the draft sets 706 of tokens generated for each of the requests 704 according to comparison of a waterline to a ratio of marginal profit to marginal cost. For draft sets of tokens with ratios above the waterline, the LLM functionality 124 and/or the draft set selection functionality 128 may allocate a suitable slot of the token bus 702 to the draft sets of tokens based on costs assigned to the slots. For example, a first draft set 706a and a fifth draft set 706b of the plurality of draft sets of tokens may have ratios greater than the waterline, and may be allocated to specific slots of the token bus 702 as illustrated in FIG. 7.

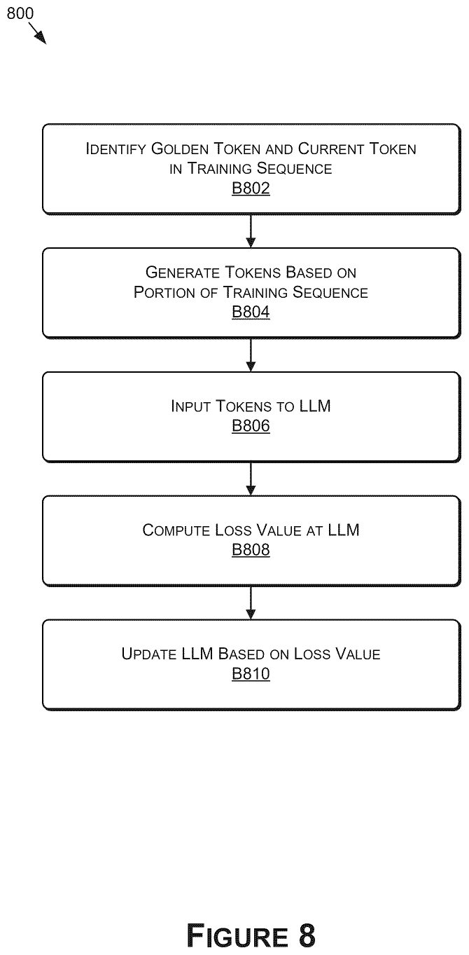

Now referring to FIG. 8, each block of a method 800, described herein, includes a computing process that may be performed using any combination of hardware, firmware, and/or software. For instance, various functions may be carried out using one or more processors (e.g., the processor(s) 110) executing instructions stored in one or more memories. The method 800 may also be embodied as computer-usable instructions stored on computer storage media. The method 800 may be provided by a standalone application, a service or hosted service (standalone or in combination with another hosted service), as a microservice via an application programming interface (API) or a plug-in to another product, to name a few. In addition, the method 800 is described, by way of example, with respect to a system implementing the LLM functionality 124 of FIG. 1, the data augmentation functionality 126 of FIG. 1, the data augmentation process 200 of FIG. 2, and the training process 400 of FIG. 4. However, this method 800 may additionally or alternatively be executed by any one system, or any combination of systems, including, but not limited to, those described herein. By way of a non-limiting example, the data augmentation functionality 126 (e.g., performed by the processor(s) 110) may perform at least a portion of the method 800.

FIG. 8 is a flow diagram showing a method 800 for training a neural network to perform text prediction using augmented data, in accordance with some embodiments of the present disclosure. In at least one embodiment, the method 800 includes operations that are performed to train a LLM as described above, with reference to FIG. 4. In at least one embodiment, the LLM (e.g., the LLM(s) 130) trained using the method 800 is implemented by the LLM functionality 124.

The method 800, at block B802, includes identifying a golden token (e.g., the golden token 208) and a current token (e.g., the current token 206) in a training or ground truth sequence (e.g., the training sequence 202) of tokens. For example, the ground truth sequence may represent one or more words in a string of text, such as a sentence or portion thereof. The golden token may be a token in the ground truth sequence that follows one or more tokens in the training sequence that were previously used to generate additional tokens that were input to the LLM, for example, to train the LLM. One or more previous tokens (e.g., the previous token(s) 204) may be positioned in the ground truth sequence before the current token.

At block B804, the method 800 includes generating one or more tokens, e.g., additional tokens (e.g., the sets 216 of tokens), based on a portion of the ground truth sequence. In at least one embodiment, as described above, the additional tokens are generated to augment a training dataset to be input to the LLM to train the LLM to perform text prediction or generation. As an example, a window (e.g., the window 214) centered about the current token (e.g., the current token 206) may be applied to the ground truth sequence and one or more additional tokens may be generated based on the tokens within the window. The one or more additional tokens may include varying quantities of ground truth tokens selected from within the window and may therefore be of differing lengths. Furthermore, the one or more additional tokens may be used to generate input sequences (e.g., the input sequences 222₁-222ₘ) by appending the additional tokens from the ground truth sequence to the previous tokens (e.g., the previous token(s) 204), which may be tokens previously predicted by the LLM or indicated (e.g., by a user) to be relevant to the ground truth sequence. Each of the additional tokens and/or input sequences is associated with the golden token. The one or more additional tokens and/or input sequences may be included in a batch that is to be input to the LLM.

The method 800, at block B806, includes inputting the additional tokens (e.g., the batch) to the LLM (e.g., the LLM 402). In at least one embodiment, the additional tokens of the batch are provided to the LLM in parallel to be processed in parallel by the LLM to produce output tokens (e.g., items within the output vector 404). The additional tokens (e.g., the sets 216 of tokens) may each include a set of tokens representing one or more terms (e.g., words). The additional tokens and/or input sequences may be provided as a vector (e.g., the vector 217) to the LLM (e.g., the LLM 402). The entries of the vector are each associated with the golden token.

At block B808, the method 800 includes computing a loss value corresponding to the additional tokens at the LLM. For example, the LLM may compute a loss value (e.g., loss values L⁰-L^{m}) for each of the additional tokens in the batch by comparing output generated by the LLM for each additional token to the golden token. A vector-level or batch loss value (e.g., loss value L_{augm} as described above) may be calculated for the batch using a vector-level or batch loss function that sums products of computed token loss, for example, modified by associated hyperparameter values, such as a series weights.

At block B810, the method 800 includes updating the LLM based on the computed batch loss value. In at least one embodiment, updating the LLM includes computing gradients using the batch loss value and updating the LLM parameters (e.g., weights), using the computed gradients. In at least one embodiment, the method 800 may terminate after block B810.

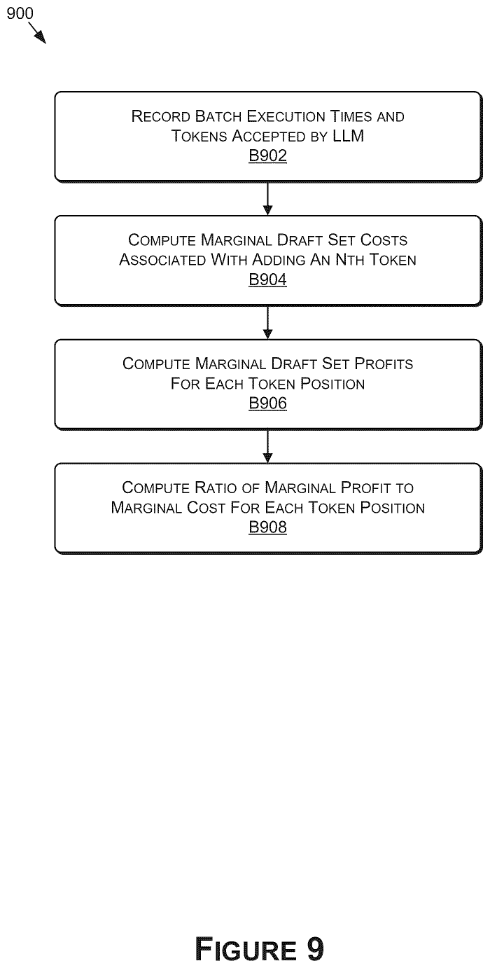

Now referring to FIG. 9, each block of a method 900, described herein, includes a computing process that may be performed using any combination of hardware, firmware, and/or software. For instance, various functions may be carried out using one or more processors executing instructions stored in one or more memories. The method 900 may also be embodied as computer-usable instructions stored on computer storage media. The method 900 may be provided by a standalone application, a service or hosted service (standalone or in combination with another hosted service), as a microservice via an application programming interface (API) or a plug-in to another product, to name a few. In addition, the method 900 is described, by way of example, with respect to a system implementing the process 500 of FIG. 5, the workflow 600 of FIG. 6, and the process 700 of FIG. 7. However, referring to FIG. 9, this method 900 may additionally or alternatively be executed by any one system, or any combination of systems, including, but not limited to, those described herein. By way of a non-limiting example, the draft set selection functionality 128 (e.g., performed by the processor(s) 110) may perform at least a portion of the method 900.

FIG. 9 is a flow diagram showing the method 900 for collecting information to be used to select draft sets of tokens at inference time, in accordance with some embodiments of the present disclosure. The method 900, at block B902, includes collecting information (e.g., historical data) related to previously performed inferences with respect to a set of batches. In at least one embodiment, at block B902, the method may include profiling or recording (e.g., storing or logging in memory) a total number of tokens and a total inference time corresponding to each of the set of batches are recorded. At block B902, the method may include recording a count of tokens for each of a plurality of token positions that were accepted by an LLM when preforming previous inference operations. In at least one embodiment, the LLM has been trained as described with respect to the data augmentation process 200 of FIG. 2, the training process 400 of FIG. 4, and/or the method 800 of FIG. 8. The tokens may include, for example, draft sets of tokens selected or generated based on an input sequence. In at least one embodiment, the tokens accepted by the LLM may correspond to a batch of requests that are input to the LLM as a set of input queries or prompts that are to be processed by the LLM. In one example, the LLM may process the batch of requests in parallel when the LLM is implemented at one or more accelerators, such as one or more GPUs. The batch of requests may be provided to a LLM inference engine, as described above in connection with FIG. 6, to infer text using lookahead speculative decoding. In at least one embodiment, at least a portion of the one or more LLMs (e.g., the LLM(s) 130) used by the method 900 is/are implemented by the LLM functionality 124.

At block B904, the method 900 includes computing marginal draft set costs associated with adding an Nth token (e.g., the last row of Table A and the fourth row of Table B). In at least one embodiment, the marginal draft set costs are computed using information obtained in block B902. In at least one embodiment, the marginal costs of the draft sets of tokens are computed as described above, e.g., by calculating the marginal costs based on an average inference time for a total number of tokens. As an example, the marginal costs may be determined as described above in connection with Table A.

The method 900 further includes, at block B906, computing a marginal draft set profit for each token position (e.g., the third row of Table B). In at least one embodiment, the marginal draft set profits are computed using information obtained in block B902. In at least one embodiment, the marginal draft set profits are computed as described herein, e.g., by determining a number of accepted draft sets of tokens that include a token at each of a plurality of token positions. For example, for each accepted draft set of one or more tokens, a count associated with each position for which the accepted draft set includes a token may be increased (e.g., by a count of 1). The count at each position may be divided by a number of intervals that the count was updated to determine the marginal draft set profits. In at least one embodiment, the marginal draft set profits are determined as described above in connection with Table B.

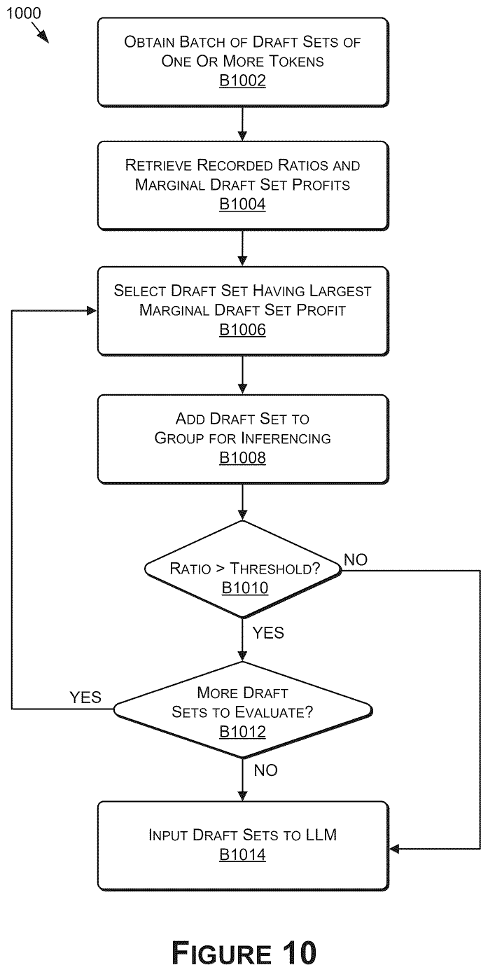

At block B908, the method 900 includes computing ratios (e.g., the last row of Table B) of marginal profit (determined at block B906) to marginal cost (determined at block B904) for each position or slot of a draft set (which may include a sequence of tokens). In at least one embodiment, the ratios are determined as described above in connection with Table B. The ratios may be stored or logged (e.g., in memory) for future reference to be used to determine how many and a length of draft sets of tokens to be assigned to a position in a token bus (e.g., as shown by the token bus 702 of FIG. 7), for example, as described below in conjunction with FIG. 10. In at least one embodiment, the method 900 may terminate after block B908.

Now referring to FIG. 10, each block of a method 1000, described herein, comprises a computing process that may be performed using any combination of hardware, firmware, and/or software. For instance, various functions may be carried out using one or more processors executing instructions stored in one or more memories. The method 1000 may also be embodied as computer-usable instructions stored on computer storage media. The method 1000 may be provided by a standalone application, a service or hosted service (standalone or in combination with another hosted service), as a microservice via an application programming interface (API) or a plug-in to another product, to name a few. In addition, the method 1000 is described, by way of example, with respect to a system implementing the process 500 of FIG. 5, the workflow 600 of FIG. 6, and the process 700 of FIG. 7. However, this method 1000 may additionally or alternatively be executed by any one system, or any combination of systems, including, but not limited to, those described herein. By way of a non-limiting example, the draft set selection functionality 128 (e.g., performed by the processor(s) 110) may perform at least a portion of the method 1000.

FIG. 10 is a flow diagram showing the method 1000 for selecting draft sets of tokens at inference time of a LLM, in accordance with some embodiments of the present disclosure. In at least one embodiment, the LLM has been trained as described in the method 800 of FIG. 8. In at least one embodiment, the method 900 of FIG. 9 has been performed to collect information to be used by the method 1000 (see FIG. 10). In at least one embodiment, the LLM (e.g., the LLM(s) 130) used with respect to the method 1000 is implemented by the LLM functionality 124.

The method 1000, at block B1002, includes obtaining a batch of draft sets of tokens each having a length. The draft sets of tokens may be obtained from one or more drafters (e.g., like the drafter(s) 502).

The method 1000, at block B1004, includes retrieving recorded marginal draft set profits and recorded ratios of marginal draft set profit to marginal draft set cost. In at least one embodiment, the ratios and marginal profits are computed as described in the method 900 of FIG. 9. The method 1000, at block B1002, may include retrieving only those recorded ratios and marginal draft set profits relevant to the lengths of the draft sets of tokens in the batch received at block B1002. For example, if the longest draft set in the batch includes four tokens, the method may include retrieving the recorded ratios and marginal draft set profits for only one, two, three, and four tokens. The method 1000, at block B1002, may include associating each of the draft sets of tokens with a marginal draft set profit associated with the length of the draft set. For example, referring to Table B, if a draft set includes three tokens, that draft set may be associated with a marginal draft set profit of 0.33.

The method 1000, at block B1006, includes selecting a draft set from the batch associated with a greatest marginal draft set profit.

The method 1000, at block B1008, includes adding the selected draft set to a group of one or more draft sets of tokens to be input to the LLM (e.g., places the selected draft set in a slot on the token bus 702).

At decision block B1010, the method 1000 includes determining if the ratio for a selected draft set is greater than a threshold value (e.g., a waterline). In at least one embodiment, the threshold value is a value above which an acceptance rate of the LLM is high enough to justify a cost of processing any additional tokens having the same length as the selected draft set (in addition to other draft sets of tokens in a set to be processed by the LLM). The decision at decision block B1010 is “NO,” if the ratio is equal to or less than the threshold value. If the decision at decision block B1010 is “NO,” the method 1000 includes proceeding to block B1014. On the other hand, the decision at decision block B1010 is “YES,” if the ratio is greater than the threshold value. If the decision at decision block B1010 is “YES,” the method 1000 includes proceeding to decision block B1012.

At decision block B1012, the method 1000 includes determining whether the batch includes more draft sets of tokens to evaluate. The decision at decision block B1012 is “NO,” if all of the draft sets of tokens in the batch have been evaluated. Otherwise, the decision at decision block B1010 is “YES.” If the decision at decision block B1010 is “YES,” the method 1000 includes returning to block B1006 to select another draft set. On the other hand, if the decision at decision block B1012 is “NO,” the method 1000 includes proceeding to block B1014.

The method 1000, at block B1014, includes inputting the group of draft sets of tokens into the LLM to perform lookahead speculative decoding to predict text based on the group of draft sets of tokens. In at least one embodiment, the method 1000 may terminate after block B1014.

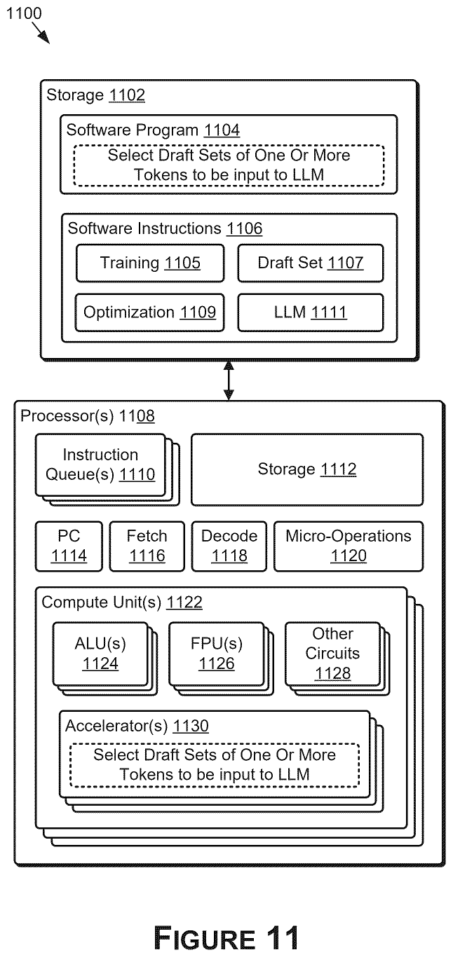

FIG. 11 illustrates a processor with modules for use in implementing at least some embodiments of the present disclosure. FIG. 11 illustrates an example of a system 1100 that can include software and hardware to cause one or more neural networks to select one or more draft sets of tokens to be input into one or more neural networks based at least on multiple amounts of processing time and multiple numbers of accepted tokens associated with multiple numbers of tokens, and cause the one or more neural networks to use the one or more draft sets of tokens to generate one or more predictions, according to at least one embodiment. System 1100 can include storage 1102 and processor(s) 1108. Storage 1102 can include, for example, memory, cache, or other storage described further herein. Storage 1102 can be separate from processor(s) 1108, or storage 1102 can be included in processor(s) 1108 (e.g., in storage 1112). In at least one embodiment, software program 1104 and/or software instructions 1106 can be stored in memory, cache, or other storage and provided to processor(s) 1108 to cause one or more circuits of processor(s) 1108 to perform operations described herein. In at least one embodiment, software program 1104 and/or software instructions 1106 can be integrated into one or more circuits of processor(s) 1108. Software program 1104, which can be used to perform any of the operations described herein, may be stored on storage 1102.

In at least one embodiment, software program 1104 can include one or more software modules. In at least one embodiment, software program 1104 includes a training module 1105, a draft set module 1107, an optimization module 1109, and a LLM module 1111. The training module 1105 includes one or more instructions to train a neural network, such as one or more LLMs of the LLM module 1111, to increase a number of tokens accepted by a LLM to perform inferencing tasks. For example, the training module 1105 may include one or more instructions to cause multiple tokens to be generated from a prompt or input sequence and the tokens to be input to an LLM, as described above, for example, in connection with FIGS. 1-10. The training module 1105 may further include instructions to compute one or more losses according to more or more loss functions to cause a LLM to be updated accordingly. In at least one embodiment, the training module 1105 may implement at least a portion of the LLM functionality 124, and/or at least a portion of the data augmentation functionality 126.

The draft set module 1107 may include one or more instructions to cause one or more draft sets of tokens to be generated based on one or more input sequence or prompts. For example, the draft set module 1107 may cause draft sets of tokens to be generated from a prompt using extracted or selected portions of the prompt. As an example, the prompt may be a string of text and draft sets of tokens may be generated as units of text based on the string. In one example, the draft sets of tokens may be of varying lengths. In at least one embodiment, the draft sets of tokens generated at the draft set module 1107 may be provided to the optimization module 1109. In at least one embodiment, the draft set module 1107 may implement the drafter(s) 502.

The optimization module 1109 may include one or more instructions to optimize input of draft sets of tokens into a LLM during an inference phase performed by the LLM. For example, marginal draft set costs and marginal draft set profits may be computed for draft sets of tokens received from the draft set module 1107. Ratios of marginal profits to marginal costs may be computed for each draft set, as described above, for example, in connection with FIGS. 5, 6, 9, and 10, and used to determine which draft sets of tokens are to be input to an LLM. In at least one embodiment, the optimization module 1109 may implement at least a portion of the draft set selection functionality 128.

The LLM module 1111 may include one or more LLMs that are trained according to training module 1105. In at least one embodiment, a trained LLM of the LLM module 1111 receives a group of one or more draft sets of tokens from the optimization module 1109 and performs inferencing on the group of draft sets of tokens. For example, the group of draft sets of tokens may include units of text and a trained LLM may infer text that follows each of the draft sets of tokens. In at least one embodiment, the LLM module 1111 may implement at least a portion of the LLM functionality 124.

In at least one embodiment, as used in any implementation described herein, unless otherwise clear from context or stated explicitly to the contrary, a module refers to any combination of software logic, firmware logic, hardware logic, and/or circuitry configured to provide functionality described herein. In at least one embodiment, software is embodied as a software package, code and/or instruction set or instructions, and “hardware,” as used in any implementation described herein, includes, for example, singly or in any combination, hardwired circuitry, programmable circuitry, state machine circuitry, fixed function circuitry, execution unit circuitry, and/or firmware that stores instructions performed by programmable circuitry. In at least one embodiment, modules are, collectively or individually, embodied as circuitry that forms part of a larger system, for example, an integrated circuit (IC), system on-chip (SoC), and so forth. In at least one embodiment, a module performs one or more processes in connection with any suitable processing unit and/or combination of processing units, such as one or more CPUs, GPUs, GPGPUs, PPUs, and/or variations thereof including those further described herein.

In at least one embodiment, software program 1104 can include a collection of software code, commands, instructions, or other sequences of text to instruct a computing device to perform one or more computational operations and/or invoke one or more other sets of instructions, Instruction Set Architecture (ISA) level instructions, to be executed or otherwise performed. Instructions (e.g., hardware instructions) or microcode can involve ISA level instructions, which can include native ISA instructions or non-native ISA instructions. Software program 1104 and/or software instructions 1106 (e.g., one or more modules) can be distributed among multiple processors that communicate over a bus, network, by writing to shared memory, and/or any suitable communication process such as those described herein.

In at least one embodiment, system 1100 can include one or more software libraries 1106 that can, for example, provide one or more APIs and/or ISA instructions. In at least one embodiment, one or more APIs and/or ISA instructions can be used to cause one or more neural networks to generate one or more responses to one or more user queries based at least on information associated with the one or more users updated in response to the one or more user queries. In at least one embodiment, one or more software instructions 1106 can be included in drivers and/or runtimes. In at least one embodiment, software instructions 1106 (e.g., including one or more APIs and/or ISA instructions) can include sets of software instructions that, if executed or otherwise performed, cause processor(s) 1108 to perform one or more computational operations, such as any of the operations described herein. In at least one embodiment, one or more APIs and/or ISA instructions can be distributed or otherwise provided as a part of one or more software instructions 1106, runtimes, drivers, and/or any other grouping of software and/or executable code further described herein. In at least one embodiment, one or more APIs and/or ISA instructions can perform one or more computational operations in response to invocation by software program 1104.

Processor(s) 1108 may include any number of processors and any suitable processing unit and/or combination of processing units, such as, but not limited to, central processing units (“CPUs”), graphics processing units (“GPUs”), or other processors (including accelerators, field programmable gate arrays (FPGAs), graphics processors, parallel processors, GPGPUs, DPUs, and/or variations thereof including those further described herein), including any processors described herein, such as, but not limited to, processors in FIGS. 14 and 15. In at least one embodiment, processor(s) 1108 can retrieve or fetch instructions (e.g., one or more APIs and/or ISA instructions) from storage 1102 using, for example, instruction fetch 1116 (e.g., for an Instruction Fetch stage). Instructions can include instructions to cause one or more neural networks to generate one or more responses to one or more user queries based at least on information associated with the one or more users updated in response to the one or more user queries. In at least one embodiment, processor(s) 1108 can include storage 1112 and instruction queue 1110 to store and queue instructions fetched from storage 1102. In at least one embodiment, fetched instructions can be decoded by decode 1118 to determine what operation should be performed by processor(s) 1108 (e.g., in an Instruction Decode stage). In at least one embodiment, processor(s) 1108 can fetch additional operands (data) that may be used for instructions, and operands can be stored, e.g., in registers or storage 1112. In at least one embodiment, micro-operations 1120 can perform operations on data stored in one or more registers or storage 1112. For example, each step of instructions fetched by processor(s) 1108 can be decomposed during execution so processor(s) 1108 can execute instructions in steps through a series of micro-operations 1120. In at least one embodiment, program counter (PC) 1114 can hold an address for a next instruction and can be updated to point to the next instruction to be executed by processor(s) 1108.

In at least one embodiment, processor(s) 1108 can perform instructions (e.g., in an Execution stage). For example, processor(s) 1108 can perform an operation specified by the instructions, such as an arithmetic operation, a logical operation, or a data transfer. In at least one embodiment, compute unit(s) 1122 can execute instructions to perform any of the operations described herein. In at least one embodiment, compute unit(s) can include ALU(s) 1124 (Arithmetic Logic Units), which may be used for performing arithmetic and logical operations. In at least one embodiment, compute unit(s) can include FPU(s) (Floating Point Units) 1126, which may be used for performing floating-point calculations. In at least one embodiment, other circuits 1128 can be used to perform other operations, such as vector and/or scalar operations. In at least one embodiment, accelerator(s) 1130 can include one or more matrix multiplication accelerators, one or more parallel processing units (PPUs), such as GPUs, or any other accelerator or processor further described herein. In at least one embodiment, software program 1104 can utilize one or more APIs and/or ISA instructions to perform various computing operations with accelerator(s) 1130, such as matrix multiplication, arithmetic operations, or any other computing operation further described herein. In at least one embodiment, one or more computing operations using accelerator(s) 1130 can include at least one or more groups of computing operations to be accelerated by execution at least in part by accelerator(s) 1130, including to cause one or more neural networks to generate one or more responses to one or more user queries based at least on information associated with the one or more users updated in response to the one or more user queries.

In at least one embodiment, system 1100 can be used to perform one or more instructions that include functions or operations, such as those above, for example, in connection with FIGS. 1-10. In at least one embodiment, system 1100 comprising one or more processors causes one or more circuits to cause one or more neural networks to generate one or more responses to one or more user queries based at least on information associated with the one or more users updated in response to the one or more user queries and/or otherwise perform operations described herein. In at least one embodiment, system 1100 is included in and/or otherwise includes systems illustrated in FIGS. 1-10 to cause one or more circuits to select one or more draft sets of tokens to be input into one or more neural networks based at least on multiple amounts of processing time and multiple numbers of accepted tokens associated with multiple numbers of tokens, and cause the one or more neural networks to use the one or more draft sets of tokens to generate one or more predictions and/or otherwise perform operations described herein. In at least one embodiment, system 1100 includes one or more hardware element or component illustrated in FIGS. 1-10, such as to select one or more draft sets of tokens to be input into one or more neural networks based at least on multiple amounts of processing time and multiple numbers of accepted tokens associated with multiple numbers of tokens, cause the one or more neural networks to use the one or more draft sets of tokens to generate one or more predictions, and/or otherwise perform operations described herein.

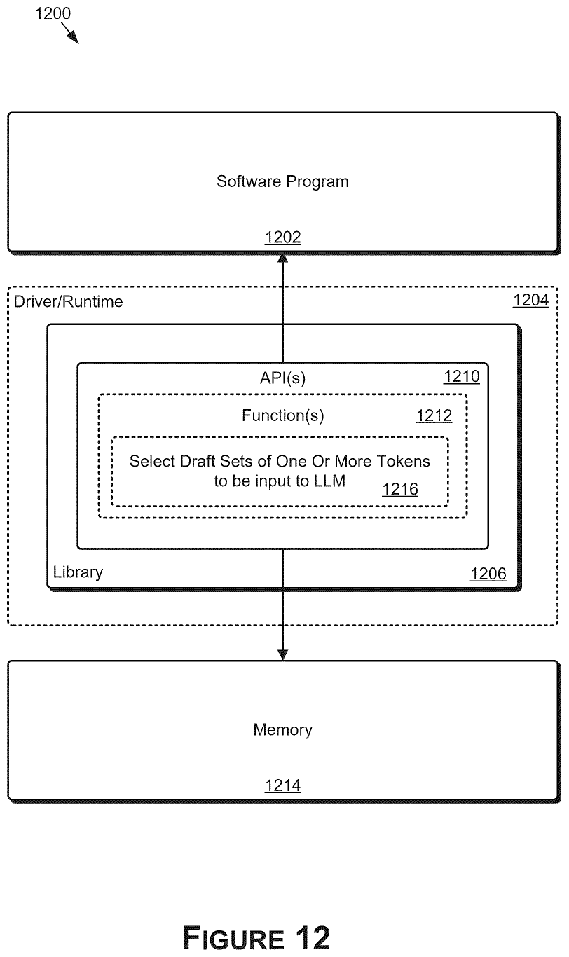

FIG. 12 is a block diagram 1200 illustrating a driver and/or runtime including one or more libraries to provide one or more application programming interfaces (APIs), according to at least one embodiment. In at least one embodiment, a software program 1202 is a software module. In at least one embodiment, a software program 1202 includes one or more software modules. In at least one embodiment, one or more APIs 1210 are sets of software instructions that, if executed, cause one or more processors to perform one or more computational operations. In at least one embodiment, one or more APIs 1210 are distributed or otherwise provided as a part of one or more libraries 1206, runtimes and/or drivers 1204, and/or any other grouping of software and/or executable code further described herein. In at least one embodiment, one or more APIs 1210 perform one or more computational operations in response to invocation by software programs 1202. In at least one embodiment, a software program 1202 is a collection of software code, commands, instructions, or other sequences of text to instruct a computing device to perform one or more computational operations and/or invoke one or more other sets of instructions, such as APIs 1210 or API functions 1212, to be executed.

In at least one embodiment, API functions 1212 included but are not limited functions to generate draft sets of tokens from input sequences or prompts, to optimize input of draft sets of tokens to a LLM, to perform processing of the draft sets of tokens at the LLM and to obtain one or more predictions output by the LLM. In at least one embodiment, functionality provided by one or more APIs 1210 include software functions 1212, such as those usable to accelerate one or more portions of software programs 1202 using one or more parallel processing units (PPUs), such as graphics processing units (GPUs). In at least one embodiment, a software program is a compiler.

In at least one embodiment, APIs 1210 are hardware interfaces to one or more circuits to perform one or more computational operations. In at least one embodiment, one or more software APIs 1210 described herein are implemented as one or more circuits to perform one or more techniques above, for example, in conjunction with FIGS. 1-10. In at least one embodiment, one or more software programs 1202 includes instructions that, if executed, cause one or more hardware devices and/or circuits to perform one or more techniques such as one or more techniques described above in conjunction with FIGS. 1-10.

In at least one embodiment, software programs 1202, such as user-implemented software programs, utilize one or more application programming interfaces (APIs) 1210 to perform various computing operations, such as memory reservation, matrix multiplication, arithmetic operations, or any computing operation performed by parallel processing units (PPUs), such as graphics processing units (GPUs), as further described herein. In at least one embodiment, one or more APIs 1210 provide a set of callable functions 1212, referred to herein as APIs, API functions, and/or functions, that individually perform one or more computing operations, such as computing operations related to parallel computing. In at least one embodiment, one or more APIs 1210 provide functions 1212 to perform one or more allocation APIs. In at least one embodiment, one or more APIs 1210 provide functions 1212 to cause a neural network to perform one or more operations, such as by returning a called function to a processor where said processor invokes said neural network. In at least one embodiment, one or more APIs 1210 provide functions 1212 to execute an application programming interface to cause software to be corrected based on a previous version of said software 1216.

In at least one embodiment, one or more software programs 1202 interact or otherwise communicate with one or more APIs 1210 to perform one or more computing operations using one or more PPUs, such as GPUs. In at least one embodiment, one or more computing operations using one or more PPUs include at least one or more groups of computing operations to be accelerated by execution at least in part by said one or more PPUs. In at least one embodiment, one or more software programs 1202 interact with one or more APIs 1210 to facilitate parallel computing using a remote or local interface.

In at least one embodiment, an interface is software instructions that, if executed, provide access to one or more functions 1212 provided by one or more APIs 1210. In at least one embodiment, a software program 1202 uses a local interface when a software developer compiles one or more software programs 1202 in conjunction with one or more libraries 1206 including or otherwise providing access to one or more APIs 1210. In at least one embodiment, one or more software programs 1202 are compiled statically in conjunction with pre-compiled libraries 1206 or uncompiled source code including instructions to perform one or more APIs 1210. In at least one embodiment, one or more software programs 1202 are compiled dynamically and said one or more software programs utilize a linker to link to one or more pre-compiled libraries 1206 including one or more APIs 1210.

In at least one embodiment, a software program 1202 uses a remote interface when a software developer executes a software program that utilizes or otherwise communicates with a library 1206 including one or more APIs 1210 over a network or other remote communication medium. In at least one embodiment, one or more libraries 1206 including one or more APIs 1210 are to be performed by a remote computing service, such as a computing resource services provider. In another embodiment, one or more libraries 1206 including one or more APIs 1210 are to be performed by any other computing host providing said one or more APIs 1210 to one or more software programs 1202.

In at least one embodiment, a processor performing or using one or more software programs 1202 calls, uses, performs, or otherwise implements one or more APIs 1210 to allocate and otherwise manage memory to be used by said software programs 1202. In at least one embodiment, one or more software programs 1202 utilize one or more APIs 1210 to allocate and otherwise manage memory to be used by one or more portions of said software programs 1202 to be accelerated using one or more PPUs, such as GPUs or any other accelerator or processor further described herein. Those software programs 1202 request a neural network to generate a modified bounding box based at least on one or more second bounding boxes.

In at least one embodiment, an API 1210 is an API to facilitate parallel computing. In at least one embodiment, an API 1210 is any other API further described herein. In at least one embodiment, an API 1210 is provided by a driver and/or runtime 1204. In at least one embodiment, an API 1210 is provided by a CUDA user-mode driver. In at least one embodiment, an API 1210 is provided by a CUDA runtime. In at least one embodiment, a driver 1204 is data values and software instructions that, if executed, perform or otherwise facilitate operation of one or more functions 1212 of an API 1210 during load and execution of one or more portions of a software program 1202. In at least one embodiment, a runtime 1204 is data values and software instructions that, if executed, perform or otherwise facilitate operation of one or more functions 1212 of an API 1210 during execution of a software program 1202. In at least one embodiment, one or more software programs 1202 utilize one or more APIs 1210 implemented or otherwise provided by a driver and/or runtime 1204 to perform combined arithmetic operations by said one or more software programs 1202 during execution by one or more PPUs, such as GPUs.

In at least one embodiment, one or more software programs 1202 utilize one or more APIs 1210 provided by a driver and/or runtime 1204 to perform combined arithmetic operations of one or more PPUs, such as GPUs. In at least one embodiment, one or more APIs 1210 provide combined arithmetic operations through a driver and/or runtime 1204, as described above. In at least one embodiment, one or more software programs 1202 utilize one or more APIs 1210 provided by a driver and/or runtime 1204 to allocate or otherwise reserve one or more blocks of memory 1214 of one or more PPUs, such as GPUs. In at least one embodiment, one or more software programs 1202 utilize one or more APIs 1210 provided by a driver and/or runtime 1204 to allocate or otherwise reserve blocks of memory. In at least one embodiment, one or more APIs 1210 are to perform combined arithmetic operations, such as those described below in conjunction with any of FIGS. 1-10.

To improve software programs 1202 usability and/or optimization of one or more portions of said software programs 1202 to be accelerated by one or more PPUs, such as GPUs, in an embodiment, one or more APIs 1210 provide one or more API functions 1212 to perform a software correction system usable or used by one or more computing devices as described above and further described, for example, in conjunction with FIGS. 1-10. In at least one embodiment, a block diagram 1200 depicts a processor, including one or more circuits to perform one or more software programs to combine two or more application programming interfaces (APIs) into a single API. In at least one embodiment, a block diagram 1200 depicts a system, including one or more processors to perform one or more software programs to combine two or more application programming interfaces (APIs) into a single API.

In at least one embodiment, at least a portion of block diagram 1200 is implemented using at least a portion of any system(s) depicted in and/or described with respect to FIGS. 13A to 15. In at least one embodiment, block diagram 1200 is performed by one or more of processor(s) used to implement the process 500 of FIG. 5, the workflow 600 of FIG. 6, and the process 700 of FIG. 7.

The systems and methods described herein may be used for a variety of purposes, by way of example and without limitation, for machine (e.g., robot, vehicle, construction machinery, warehouse vehicles/machines, autonomous, semi-autonomous, and/or other machine types) control, machine locomotion, machine driving, synthetic data generation, model training (e.g., using real, augmented, and/or synthetic data, such as synthetic data generated using a simulation platform or system, synthetic data generation techniques such as but not limited to those described herein, etc.), perception, augmented reality (AR), virtual reality (VR), mixed reality (MR), robotics, security and surveillance (e.g., in a smart cities implementation), autonomous or semi-autonomous machine applications, deep learning, environment simulation, object or actor simulation and/or digital twinning, data center processing, conversational AI, light transport simulation (e.g., ray-tracing, path tracing, etc.), distributed or collaborative content creation for 3D assets (e.g., using universal scene descriptor (USD) data, such as OpenUSD, and/or other data types), cloud computing, generative artificial intelligence (e.g., using one or more diffusion models, transformer models, etc.), and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot or robotic platform, aerial systems, medial systems, boating systems, smart area monitoring systems, systems for performing deep learning operations, systems for performing simulation operations (e.g., in a driving or vehicle simulation, in a robotics simulation, in a smart cities or surveillance simulation, etc.), systems for performing digital twin operations (e.g., in conjunction with a collaborative content creation platform or system, such as, without limitation, NVIDIA's OMNIVERSE and/or another platform, system, or service that uses USD or OpenUSD data types), systems implemented using an edge device, systems incorporating one or more virtual machines (VMs), systems for performing synthetic data generation operations (e.g., using one or more neural rendering fields (NERFs), gaussian splat techniques, diffusion models, transformer models, etc.), systems implemented at least partially in a data center, systems for performing conversational AI operations, systems implementing one or more language models-such as one or more large language models (LLMs), one or more vision language models (VLMs), one or more multi-modal language models, etc., systems for performing light transport simulation, systems for performing collaborative content creation for 3D assets (e.g., using universal scene descriptor (USD) data, such as OpenUSD, computer aided design (CAD) data, 2D and/or 3D graphics or design data, and/or other data types), systems implemented at least partially using cloud computing resources, and/or other types of systems. In at least one embodiment, any one of the systems described above may include one or more processors to select one or more draft sets of tokens to be input into one or more neural networks based at least on multiple amounts of processing time and multiple numbers of accepted tokens associated with multiple numbers of tokens; cause the one or more neural networks to use the one or more draft sets of tokens to generate one or more predictions; and/or perform one or more other operations such as those described herein.

### Example Language Models

In at least some embodiments, language models, such as large language models (LLMs), vision language models (VLMs), multi-modal language models (MMLMs), and/or other types of generative artificial intelligence (AI) may be implemented. These models may be capable of understanding, summarizing, translating, and/or otherwise generating text (e.g., natural language text, code, etc.), images, video, computer aided design (CAD) assets, OMNIVERSE and/or METAVERSE file information (e.g., in USD format, such as OpenUSD), and/or the like, based on the context provided in input prompts or queries. These language models may be considered “large,” in embodiments, based on the models being trained on massive datasets and having architectures with large number of learnable network parameters (weights and biases)—such as millions or billions of parameters. The LLMs/VLMs/MMLMs/etc. may be implemented for summarizing textual data, analyzing and extracting insights from data (e.g., textual, image, video, etc.), and generating new text/image/video/etc. in user-specified styles, tones, and/or formats. The LLMs/VLMs/MMLMs/etc. of the present disclosure may be used exclusively for text processing, in embodiments, whereas in other embodiments, multi-modal LLMs may be implemented to accept, understand, and/or generate text and/or other types of content like images, audio, 2D and/or 3D data (e.g., in USD formats), and/or video. For example, vision language models (VLMs), or more generally multi-modal language models (MMLMs), may be implemented to accept image, video, audio, textual, 3D design (e.g., CAD), and/or other inputs data types and/or to generate or output image, video, audio, textual, 3D design, and/or other output data types. In at least one embodiment, any of the LLMs/VLMs/MMLMs/etc. may be utilized in a system with one or more processors to select one or more draft sets of tokens to be input into one or more neural networks based at least on multiple amounts of processing time and multiple numbers of accepted tokens associated with multiple numbers of tokens, cause the one or more neural networks to use the one or more draft sets of tokens to generate one or more predictions, and/or perform one or more other operations such as those described herein.

Various types of LLMs/VLMs/MMLMs/etc. architectures may be implemented in various embodiments. For example, different architectures may be implemented that use different techniques for understanding and generating outputs-such as text, audio, video, image, 2D and/or 3D design or asset data, etc. In some embodiments, LLMs/VLMs/MMLMs/etc. architectures such as recurrent neural networks (RNNs) or long short-term memory networks (LSTMs) may be used, while in other embodiments transformer architectures—such as those that rely on self-attention and/or cross-attention (e.g., between contextual data and textual data) mechanisms—may be used to understand and recognize relationships between words or tokens and/or contextual data (e.g., other text, video, image, design data, USD, etc.). One or more generative processing pipelines that include LLMs/VLMs/MMLMs/etc. may also include one or more diffusion block(s) (e.g., denoisers). The LLMs/VLMs/MMLMs/etc. of the present disclosure may include encoder and/or decoder block(s). For example, discriminative or encoder-only models like BERT (Bidirectional Encoder Representations from Transformers) may be implemented for tasks that involve language comprehension such as classification, sentiment analysis, question answering, and named entity recognition. As another example, generative or decoder-only models like GPT (Generative Pretrained Transformer) may be implemented for tasks that involve language and content generation such as text completion, story generation, and dialogue generation. LLMs/VLMs/MMLMs/etc. that include both encoder and decoder components like T5 (Text-to-Text Transformer) may be implemented to understand and generate content, such as for translation and summarization. These examples are not intended to be limiting, and any architecture type-including but not limited to those described herein—may be implemented depending on the particular embodiment and the task(s) being performed using the LLMs/VLMs/MMLMs/etc.

In various embodiments, the LLMs/VLMs/MMLMs/etc. may be trained using unsupervised learning, in which an LLMs/VLMs/MMLMs/etc. learns patterns from large amounts of unlabeled text/audio/video/image/design/USD/etc. data. In at least one embodiment, when a LLM is implemented, the LLM may be trained to increase its acceptance rate, as described above, for example, in conjunction with FIGS. 1-10. Due to the extensive training, in embodiments, the models may not require task-specific or domain-specific training. LLMs/VLMs/MMLMs/etc. that have undergone extensive pre-training on vast amounts of unlabeled data may be referred to as foundation models and may be adept at a variety of tasks like question-answering, summarization, filling in missing information, translation, image/video/design/USD/data generation. Some LLMs/VLMs/MMLMs/etc. may be tailored for a specific use case using techniques like prompt tuning, fine-tuning, retrieval augmented generation (RAG), adding adapters (e.g., customized neural networks, and/or neural network layers, that tune or adjust prompts or tokens to bias the language model toward a particular task or domain), and/or using other fine-tuning or tailoring techniques that optimize the models for use on particular tasks and/or within particular domains.

In some embodiments, the LLMs/VLMs/MMLMs/etc. of the present disclosure may be implemented using various model alignment techniques. For example, in some embodiments, guardrails may be implemented to identify improper or undesired inputs (e.g., prompts) and/or outputs of the models. In doing so, the system may use the guardrails and/or other model alignment techniques to either prevent a particular undesired input from being processed using the LLMs/VLMs/MMLMs/etc., and/or preventing the output or presentation (e.g., display, audio output, etc.) of information generating using the LLMs/VLMs/MMLMs/etc. In some embodiments, one or more additional models—or layers thereof—may be implemented to identify issues with inputs and/or outputs of the models. For example, these “safeguard” models may be trained to identify inputs and/or outputs that are “safe” or otherwise okay or desired and/or that are “unsafe” or are otherwise undesired for the particular application/implementation. As a result, the LLMs/VLMs/MMLMs/etc. of the present disclosure may be less likely to output language/text/audio/video/design data/USD data/etc. that may be offensive, vulgar, improper, unsafe, out of domain, and/or otherwise undesired for the particular application/implementation.

In some embodiments, the LLMs/VLMs/etc. may be configured to or capable of accessing or using one or more plug-ins, application programming interfaces (APIs), databases, data stores, repositories, etc. For example, for certain tasks or operations that the model is not ideally suited for, the model may have instructions (e.g., as a result of training, and/or based on instructions in a given prompt) to access one or more plug-ins (e.g., 3rd party plugins) for help in processing the current input. In such an example, where at least part of a prompt is related to restaurants or weather, the model may access one or more restaurant or weather plug-ins (e.g., via one or more APIs) to retrieve the relevant information. As another example, where at least part of a response requires a mathematical computation, the model may access one or more math plug-ins or APIs for help in solving the problem(s), and may then use the response from the plug-in and/or API in the output from the model. This process may be repeated—e.g., recursively—for any number of iterations and using any number of plug-ins and/or APIs until a response to the input prompt can be generated that addresses each ask/question/request/process/operation/etc. As such, the model(s) may not only rely on its own knowledge from training on a large dataset(s), but also on the expertise or optimized nature of one or more external resources-such as APIs, plug-ins, and/or the like.

In some embodiments, multiple language models (e.g., LLMs/VLMs/MMLMs/etc., multiple instances of the same language model, and/or multiple prompts provided to the same language model or instance of the same language model may be implemented, executed, or accessed (e.g., using one or more plug-ins, user interfaces, APIs, databases, data stores, repositories, etc.) to provide output responsive to the same query, or responsive to separate portions of a query. In at least one embodiment, multiple language models e.g., language models with different architectures, language models trained on different (e.g. updated) corpuses of data may be provided with the same input query and prompt (e.g., set of constraints, conditioners, etc.). In one or more embodiments, the language models may be different versions of the same foundation model. In one or more embodiments, at least one language model may be instantiated as multiple agents—e.g., more than one prompt may be provided to constrain, direct, or otherwise influence a style, a content, or a character, etc., of the output provided. In one or more example, non-limiting embodiments, the same language model may be asked to provide output corresponding to a different role, perspective, character, or having a different base of knowledge, etc.—as defined by a supplied prompt.

In any one of such embodiments, the output of two or more (e.g., each) language models, two or more versions of at least one language model, two or more instanced agents of at least one language model, and/or two more prompts provided to at least one language model may be further processed, e.g., aggregated, compared or filtered against, or used to determine (and provide) a consensus response. In one or more embodiments, the output from one language model—or version, instance, or agent—maybe be provided as input to another language model for further processing and/or validation. In one or more embodiments, a language model may be asked to generate or otherwise obtain an output with respect to an input source material, with the output being associated with the input source material. Such an association may include, for example, the generation of a caption or portion of text that is embedded (e.g., as metadata) with an input source text or image. In one or more embodiments, an output of a language model may be used to determine the validity of an input source material for further processing, or inclusion in a dataset. For example, a language model may be used to assess the presence (or absence) of a target word in a portion of text or an object in an image, with the text or image being annotated to note such presence (or lack thereof). Alternatively, the determination from the language model may be used to determine whether the source material should be included in a curated dataset, for example and without limitation.

FIG. 13A is a block diagram of an example generative language model system 1300 suitable for use in implementing at least some embodiments of the present disclosure. In the example illustrated in FIG. 13A, the generative language model system 1300 includes a retrieval augmented generation (RAG) component 1392, an input processor 1305, a tokenizer 1310, an embedding component 1320, plug-ins/APIs 1395, and a generative language model (LM) 1330 (which may include an LLM, a VLM, a multi-modal LM, etc.). In at least one embodiment, the generative language model 1330 may be trained to increase its acceptance rate of tokens using augmented training data and subsequently used to output predictions based on input sequences or prompts. Furthermore, the generative language model 1330 may be used with lookahead speculative decoding along with optimization of draft set length, as described herein, for example, with reference to Tables A and B, and FIGS. 5, 6, 9, and 10.

At a high level, the input processor 1305 may receive an input 1301 comprising text and/or other types of input data (e.g., audio data, video data, image data, sensor data (e.g., LiDAR, RADAR, ultrasonic, etc.), 3D design data, CAD data, universal scene descriptor (USD) data-such as OpenUSD, etc.), depending on the architecture of the generative LM 1330 (e.g., LLM/VLM/MMLM/etc.). In at least one embodiment, the input processor 1305 may be configured to select one or more draft sets of tokens to be input into one or more neural networks based at least on multiple amounts of processing time and multiple numbers of accepted tokens associated with multiple numbers of tokens, cause the one or more neural networks to use the one or more draft sets of tokens to generate one or more predictions, and/or perform one or more other operations such as those described herein. In some embodiments, the input 1301 includes plain text in the form of one or more sentences, paragraphs, and/or documents. Additionally or alternatively, the input 1301 may include numerical sequences, precomputed embeddings (e.g., word or sentence embeddings), and/or structured data (e.g., in tabular formats, JSON, or XML). In some implementations in which the generative LM 1330 is capable of processing multi-modal inputs, the input 1301 may combine text (or may omit text) with image data, audio data, video data, design data, USD data, and/or other types of input data, such as but not limited to those described herein. Taking raw input text as an example, the input processor 1305 may prepare raw input text in various ways. For example, the input processor 1305 may perform various types of text filtering to remove noise (e.g., special characters, punctuation, HTML tags, stopwords, portions of an image(s), portions of audio, etc.) from relevant textual content. In an example involving stopwords (common words that tend to carry little semantic meaning), the input processor 1305 may remove stopwords to reduce noise and focus the generative LM 1330 on more meaningful content. The input processor 1305 may apply text normalization, for example, by converting all characters to lowercase, removing accents, and/or or handling special cases like contractions or abbreviations to ensure consistency. These are just a few examples, and other types of input processing may be applied.

In some embodiments, a RAG component 1392 (which may include one or more RAG models, and/or may be performed using the generative LM 1330 itself) may be used to retrieve additional information to be used as part of the input 1301 or prompt. RAG may be used to enhance the input to the LLM/VLM/MMLM/etc. with external knowledge, so that answers to specific questions or queries or requests are more relevant-such as in a case where specific knowledge is required. The RAG component 1392 may fetch this additional information (e.g., grounding information, such as grounding text/image/video/audio/USD/CAD/etc.) from one or more external sources, which can then be fed to the LLM/VLM/MMLM/etc. along with the prompt to improve accuracy of the responses or outputs of the model.

For example, in some embodiments, the input 1301 may be generated using the query or input to the model (e.g., a question, a request, etc.) in addition to data retrieved using the RAG component 1392. In some embodiments, the input processor 1305 may analyze the input 1301 and communicate with the RAG component 1392 (or the RAG component 1392 may be part of the input processor 1305, in embodiments) in order to identify relevant text and/or other data to provide to the generative LM 1330 as additional context or sources of information from which to identify the response, answer, or output 1390, generally. For example, where the input indicates that the user is interested in a desired tire pressure for a particular make and model of vehicle, the RAG component 1392 may retrieve—using a RAG model performing a vector search in an embedding space, for example—the tire pressure information or the text corresponding thereto from a digital (embedded) version of the user manual for that particular vehicle make and model. Similarly, where a user revisits a chatbot related to a particular product offering or service, the RAG component 1392 may retrieve a prior stored conversation history—or at least a summary thereof—and include the prior conversation history along with the current ask/request as part of the input 1301 to the generative LM 1330.

The RAG component 1392 may use various RAG techniques. For example, naïve RAG may be used where documents are indexed, chunked, and applied to an embedding model to generate embeddings corresponding to the chunks. A user query may also be applied to the embedding model and/or another embedding model of the RAG component 1392 and the embeddings of the chunks along with the embeddings of the query may be compared to identify the most similar/related embeddings to the query, which may be supplied to the generative LM 1330 to generate an output.

In some embodiments, more advanced RAG techniques may be used. For example, prior to passing chunks to the embedding model, the chunks may undergo pre-retrieval processes (e.g., routing, rewriting, metadata analysis, expansion, etc.). In addition, prior to generating the final embeddings, post-retrieval processes (e.g., re-ranking, prompt compression, etc.) may be performed on the outputs of the embedding model prior to final embeddings being used as comparison to an input query.

As a further example, modular RAG techniques may be used, such as those that are similar to naïve and/or advanced RAG, but also include features such as hybrid search, recursive retrieval and query engines, StepBack approaches, sub-queries, and hypothetical document embedding.

As another example, Graph RAG may use knowledge graphs as a source of context or factual information. Graph RAG may be implemented using a graph database as a source of contextual information sent to the LLM/VLM/MMLM/etc. Rather than (or in addition to) providing the model with chunks of data extracted from larger sized documents—which may result in a lack of context, factual correctness, language accuracy, etc.—graph RAG may also provide structured entity information to the LLM/VLM/MMLM/etc. by combining the structured entity textual description with its many properties and relationships, allowing for deeper insights by the model. When implementing graph RAG, the systems and methods described herein use a graph as a content store and extract relevant chunks of documents and ask the LLM/VLM/MMLM/etc. to answer using them. The knowledge graph, in such embodiments, may contain relevant textual content and metadata about the knowledge graph as well as be integrated with a vector database. In some embodiments, the graph RAG may use a graph as a subject matter expert, where descriptions of concepts and entities relevant to a query/prompt may be extracted and passed to the model as semantic context. These descriptions may include relationships between the concepts. In other examples, the graph may be used as a database, where part of a query/prompt may be mapped to a graph query, the graph query may be executed, and the LLM/VLM/MMLM/etc. may summarize the results. In such an example, the graph may store relevant factual information, and a query (natural language query) to graph query tool (NL-to-Graph-query tool) and entity linking may be used. In some embodiments, graph RAG (e.g., using a graph database) may be combined with standard (e.g., vector database) RAG, and/or other RAG types, to benefit from multiple approaches.

In any embodiments, the RAG component 1392 may implement a plugin, API, user interface, and/or other functionality to perform RAG. For example, a graph RAG plug-in may be used by the LLM/VLM/MMLM/etc. to run queries against the knowledge graph to extract relevant information for feeding to the model, and a standard or vector RAG plug-in may be used to run queries against a vector database. For example, the graph database may interact with a plug-in's REST interface such that the graph database is decoupled from the vector database and/or the embeddings models.

The tokenizer 1310 may segment the (e.g., processed) text data into smaller units (tokens) for subsequent analysis and processing. The tokens may represent individual words, subwords, characters, portions of audio/video/image/etc., depending on the implementation. Word-based tokenization divides the text into individual words, treating each word as a separate token. Subword tokenization breaks down words into smaller meaningful units (e.g., prefixes, suffixes, stems), enabling the generative LM 1330 to understand morphological variations and handle out-of-vocabulary words more effectively. Character-based tokenization represents each character as a separate token, enabling the generative LM 1330 to process text at a fine-grained level. The choice of tokenization strategy may depend on factors such as the language being processed, the task at hand, and/or characteristics of the training dataset. As such, the tokenizer 1310 may convert the (e.g., processed) text into a structured format according to tokenization schema being implemented in the particular embodiment.

The embedding component 1320 may use any known embedding technique to transform discrete tokens into (e.g., dense, continuous vector) representations of semantic meaning. For example, the embedding component 1320 may use pre-trained word embeddings (e.g., Word2Vec, GloVe, or FastText), one-hot encoding, Term Frequency-Inverse Document Frequency (TF-IDF) encoding, one or more embedding layers of a neural network, and/or otherwise.

In some implementations in which the input 1301 includes image data/video data/etc., the input processor 1301 may resize the data to a standard size compatible with format of a corresponding input channel and/or may normalize pixel values to a common range (e.g., 0 to 1) to ensure a consistent representation, and the embedding component 1320 may encode the image data using any known technique (e.g., using one or more convolutional neural networks (CNNs) to extract visual features). In some implementations in which the input 1301 includes audio data, the input processor 1301 may resample an audio file to a consistent sampling rate for uniform processing, and the embedding component 1320 may use any known technique to extract and encode audio features-such as in the form of a spectrogram (e.g., a mel-spectrogram). In some implementations in which the input 1301 includes video data, the input processor 1301 may extract frames or apply resizing to extracted frames, and the embedding component 1320 may extract features such as optical flow embeddings or video embeddings and/or may encode temporal information or sequences of frames. In some implementations in which the input 1301 includes multi-modal data, the embedding component 1320 may fuse representations of the different types of data (e.g., text, image, audio, USD, video, design, etc.) using techniques like early fusion (concatenation), late fusion (sequential processing), attention-based fusion (e.g., self-attention, cross-attention), etc.

The generative LM 1330 and/or other components of the generative LM system 1300 may use different types of neural network architectures depending on the implementation. For example, transformer-based architectures such as those used in models like GPT may be implemented, and may include self-attention mechanisms that weigh the importance of different words or tokens in the input sequence and/or feedforward networks that process the output of the self-attention layers, applying non-linear transformations to the input representations and extracting higher-level features. Some non-limiting example architectures include transformers (e.g., encoder-decoder, decoder only, multi-modal), RNNs, LSTMs, fusion models, diffusion models, cross-modal embedding models that learn joint embedding spaces, graph neural networks (GNNs), hybrid architectures combining different types of architectures adversarial networks like generative adversarial networks or GANs or adversarial autoencoders (AAEs) for joint distribution learning, and others. As such, depending on the implementation and architecture, the embedding component 1320 may apply an encoded representation of the input 1301 to the generative LM 1330, and the generative LM 1330 may process the encoded representation of the input 1301 to generate an output 1390, which may include responsive text and/or other types of data.

As described herein, in some embodiments, the generative LM 1330 may be configured to access or use- or capable of accessing or using-plug-ins/APIs 1395 (which may include one or more plug-ins, application programming interfaces (APIs), databases, data stores, repositories, etc.). For example, for certain tasks or operations that the generative LM 1330 is not ideally suited for, the model may have instructions (e.g., as a result of training, and/or based on instructions in a given prompt, such as those retrieved using the RAG component 1392) to access one or more plug-ins/APIs 1395 (e.g., 3^{rd} party plugins) for help in processing the current input. In such an example, where at least part of a prompt is related to restaurants or weather, the model may access one or more restaurant or weather plug-ins (e.g., via one or more APIs), send at least a portion of the prompt related to the particular plug-in/API 1395 to the plug-in/API 1395, the plug-in/API 1395 may process the information and return an answer to the generative LM 1330, and the generative LM 1330 may use the response to generate the output 1390. This process may be repeated—e.g., recursively—for any number of iterations and using any number of plug-ins/APIs 1395 until an output 1390 that addresses each ask/question/request/process/operation/etc. from the input 1301 can be generated. As such, the model(s) may not only rely on its own knowledge from training on a large dataset(s) and/or from data retrieved using the RAG component 1392, but also on the expertise or optimized nature of one or more external resources—such as the plug-ins/APIs 1395.

FIG. 13B is a block diagram of an example implementation in which the generative LM 1330 includes a transformer encoder-decoder. For example, assume input text such as “Who discovered gravity” is tokenized (e.g., by the tokenizer 1310 of FIG. 13A) into tokens such as words, and each token is encoded (e.g., by the embedding component 1320 of FIG. 913A) into a corresponding embedding (e.g., of size 512). Since these token embeddings typically do not represent the position of the token in the input sequence, any known technique may be used to add a positional encoding to each token embedding to encode the sequential relationships and context of the tokens in the input sequence. As such, the (e.g., resulting) embeddings may be applied to one or more encoder(s) 1335 of the generative LM 1330.

In an example implementation, the encoder(s) 1335 forms an encoder stack, where each encoder includes a self-attention layer and a feedforward network. In an example transformer architecture, each token (e.g., word) flows through a separate path. As such, each encoder may accept a sequence of vectors, passing each vector through the self-attention layer, then the feedforward network, and then upwards to the next encoder in the stack. Any known self-attention technique may be used. For example, to calculate a self-attention score for each token (word), a query vector, a key vector, and a value vector may be created for each token, a self-attention score may be calculated for pairs of tokens by taking the dot product of the query vector with the corresponding key vectors, normalizing the resulting scores, multiplying by corresponding value vectors, and summing weighted value vectors. The encoder may apply multi-headed attention in which the attention mechanism is applied multiple times in parallel with different learned weight matrices. Any number of encoders may be cascaded to generate a context vector encoding the input. An attention projection layer 1340 may convert the context vector into attention vectors (keys and values) for the decoder(s) 1345.

In an example implementation, the decoder(s) 1345 form a decoder stack, where each decoder includes a self-attention layer, an encoder-decoder self-attention layer that uses the attention vectors (keys and values) from the encoder to focus on relevant parts of the input sequence, and a feedforward network. As with the encoder(s) 1335, in an example transformer architecture, each token (e.g., word) flows through a separate path in the decoder(s) 1345. During a first pass, the decoder(s) 1345, a classifier 1350, and a generation mechanism 1355 may generate a first token, and the generation mechanism 1355 may apply the generated token as an input during a second pass. The process may repeat in a loop, successively generating and adding tokens (e.g., words) to the output from the preceding pass and applying the token embeddings of the composite sequence with positional encodings as an input to the decoder(s) 1345 during a subsequent pass, sequentially generating one token at a time (known as auto-regression) until predicting a symbol or token that represents the end of the response. Within each decoder, the self-attention layer is typically constrained to attend only to preceding positions in the output sequence by applying a masking technique (e.g., setting future positions to negative infinity) before the softmax operation. In an example implementation, the encoder-decoder attention layer operates similarly to the (e.g., multi-headed) self-attention in the encoder(s) 1335, except that it creates its queries from the layer below it and takes the keys and values (e.g., matrix) from the output of the encoder(s) 1335.

As such, the decoder(s) 1345 may output some decoded (e.g., vector) representation of the input being applied during a particular pass. The classifier 1350 may include a multi-class classifier comprising one or more neural network layers that project the decoded (e.g., vector) representation into a corresponding dimensionality (e.g., one dimension for each supported word or token in the output vocabulary) and a softmax operation that converts logits to probabilities. As such, the generation mechanism 1355 may select or sample a word or token based on a corresponding predicted probability (e.g., select the word with the highest predicted probability) and append it to the output from a previous pass, generating each word or token sequentially. The generation mechanism 1355 may repeat the process, triggering successive decoder inputs and corresponding predictions until selecting or sampling a symbol or token that represents the end of the response, at which point, the generation mechanism 1355 may output the generated response.

FIG. 13C is a block diagram of an example implementation in which the generative LM 1330 includes a decoder-only transformer architecture. For example, the decoder(s) 1360 of FIG. 13C may operate similarly as the decoder(s) 1345 of FIG. 13B except each of the decoder(s) 1360 of FIG. 13C omits the encoder-decoder self-attention layer (since there is no encoder in this implementation). As such, the decoder(s) 1360 may form a decoder stack, where each decoder includes a self-attention layer and a feedforward network. Furthermore, instead of encoding the input sequence, a symbol or token representing the end of the input sequence (or the beginning of the output sequence) may be appended to the input sequence, and the resulting sequence (e.g., corresponding embeddings with positional encodings) may be applied to the decoder(s) 1360. As with the decoder(s) 1345 of FIG. 13B, each token (e.g., word) may flow through a separate path in the decoder(s) 1360, and the decoder(s) 1360, a classifier 1365, and a generation mechanism 1300 may use auto-regression to sequentially generate one token at a time until predicting a symbol or token that represents the end of the response. The classifier 1365 and the generation mechanism 1300 may operate similarly as the classifier 1350 and the generation mechanism 1355 of FIG. 13B, with the generation mechanism 1300 selecting or sampling each successive output token based on a corresponding predicted probability and appending it to the output from a previous pass, generating each token sequentially until selecting or sampling a symbol or token that represents the end of the response. These and other architectures described herein are meant simply as examples, and other suitable architectures may be implemented within the scope of the present disclosure.

### Example Computing Device

FIG. 14 is a block diagram of an example computing device(s) 1400 suitable for use in implementing some embodiments of the present disclosure. In at least one embodiment, computing device 1400 may be configured to select one or more draft sets of tokens to be input into one or more neural networks based at least on multiple amounts of processing time and multiple numbers of accepted tokens associated with multiple numbers of tokens, cause the one or more neural networks to use the one or more draft sets of tokens to generate one or more predictions, and/or perform one or more other operations such as those described herein. Computing device 1400 may include an interconnect system 1402 that directly or indirectly couples the following devices: memory 1404, one or more central processing units (CPUs) 1406, one or more graphics processing units (GPUs) 1408, a communication interface 1410, input/output (I/O) ports 1412, input/output components 1414, a power supply 1416, one or more presentation components 1418 (e.g., display(s)), and one or more logic units 1420. In at least one embodiment, the computing device(s) 1400 may comprise one or more virtual machines (VMs), and/or any of the components thereof may comprise virtual components (e.g., virtual hardware components). For non-limiting examples, one or more of the GPUs 1408 may comprise one or more vGPUs, one or more of the CPUs 1406 may comprise one or more vCPUs, and/or one or more of the logic units 1420 may comprise one or more virtual logic units. As such, a computing device(s) 1400 may include discrete components (e.g., a full GPU dedicated to the computing device 1400), virtual components (e.g., a portion of a GPU dedicated to the computing device 1400), or a combination thereof.

Although the various blocks of FIG. 14 are shown as connected via the interconnect system 1402 with lines, this is not intended to be limiting and is for clarity only. For example, in some embodiments, a presentation component 1418, such as a display device, may be considered an I/O component 1414 (e.g., if the display is a touch screen). As another example, the CPUs 1406 and/or GPUs 1408 may include memory (e.g., the memory 1404 may be representative of a storage device in addition to the memory of the GPUs 1408, the CPUs 1406, and/or other components). As such, the computing device of FIG. 14 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 14.

The interconnect system 1402 may represent one or more links or busses, such as an address bus, a data bus, a control bus, or a combination thereof. The interconnect system 1402 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 1406 may be directly connected to the memory 1404. Further, the CPU 1406 may be directly connected to the GPU 1408. Where there is direct, or point-to-point connection between components, the interconnect system 1402 may include a PCIe link to carry out the connection. In these examples, a PCI bus need not be included in the computing device 1400.

The memory 1404 may include any of a variety of computer-readable media. The computer-readable media may be any available media that may be accessed by the computing device 1400. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 1404 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 1400. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 1406 may be configured to execute at least some of the computer-readable instructions to control one or more components of the computing device 1400 to perform one or more of the methods and/or processes described herein. The CPU(s) 1406 may each include one or more cores (e.g., one, two, four, eight, twenty-eight, seventy-two, etc.) that are capable of handling a multitude of software threads simultaneously. The CPU(s) 1406 may include any type of processor, and may include different types of processors depending on the type of computing device 1400 implemented (e.g., processors with fewer cores for mobile devices and processors with more cores for servers). For example, depending on the type of computing device 1400, the processor may be an Advanced RISC Machines (ARM) processor implemented using Reduced Instruction Set Computing (RISC) or an x86 processor implemented using Complex Instruction Set Computing (CISC). The computing device 1400 may include one or more CPUs 1406 in addition to one or more microprocessors or supplementary co-processors, such as math co-processors.

In addition to or alternatively from the CPU(s) 1406, the GPU(s) 1408 may be configured to execute at least some of the computer-readable instructions to control one or more components of the computing device 1400 to perform one or more of the methods and/or processes described herein. One or more of the GPU(s) 1408 may be an integrated GPU (e.g., with one or more of the CPU(s) 1406 and/or one or more of the GPU(s) 1408 may be a discrete GPU. In embodiments, one or more of the GPU(s) 1408 may be a coprocessor of one or more of the CPU(s) 1406. The GPU(s) 1408 may be used by the computing device 1400 to render graphics (e.g., 3D graphics) or perform general purpose computations. For example, the GPU(s) 1408 may be used for General-Purpose computing on GPUs (GPGPU). The GPU(s) 1408 may include hundreds or thousands of cores that are capable of handling hundreds or thousands of software threads simultaneously. The GPU(s) 1408 may generate pixel data for output images in response to rendering commands (e.g., rendering commands from the CPU(s) 1406 received via a host interface). The GPU(s) 1408 may include graphics memory, such as display memory, for storing pixel data or any other suitable data, such as GPGPU data. The display memory may be included as part of the memory 1404. The GPU(s) 1408 may include two or more GPUs operating in parallel (e.g., via a link). The link may directly connect the GPUs (e.g., using NVLINK) or may connect the GPUs through a switch (e.g., using NVSwitch). When combined together, each GPU 1408 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 1406 and/or the GPU(s) 1408, the logic unit(s) 1420 may be configured to execute at least some of the computer-readable instructions to control one or more components of the computing device 1400 to perform one or more of the methods and/or processes described herein. In embodiments, the CPU(s) 1406, the GPU(s) 1408, and/or the logic unit(s) 1420 may discretely or jointly perform any combination of the methods, processes and/or portions thereof. One or more of the logic units 1420 may be part of and/or integrated in one or more of the CPU(s) 1406 and/or the GPU(s) 1408 and/or one or more of the logic units 1420 may be discrete components or otherwise external to the CPU(s) 1406 and/or the GPU(s) 1408. In embodiments, one or more of the logic units 1420 may be a coprocessor of one or more of the CPU(s) 1406 and/or one or more of the GPU(s) 1408.

Examples of the logic unit(s) 1420 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Programmable Vision Accelerator (PVAs)—which may include one or more direct memory access (DMA) systems, one or more vision or vector processing units (VPUs), one or more pixel processing engines (PPEs)—e.g., including a 2D array of processing elements that each communicate north, south, east, and west with one or more other processing elements in the array, one or more decoupled accelerators or units (e.g., decoupled lookup table (DLUT) accelerators or units), etc., Vision Processing Units (VPUs), Optical Flow Accelerators (OFAs), Field Programmable Gate Arrays (FPGAs), Neuromorphic Chips, Quantum Processing Units (QPUs), Associative Process Units (APUs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 1410 may include one or more receivers, transmitters, and/or transceivers that allow the computing device 1400 to communicate with other computing devices via an electronic communication network, included wired and/or wireless communications. The communication interface 1410 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 1420 and/or communication interface 1410 may include one or more data processing units (DPUs) to transmit data received over a network and/or through interconnect system 1402 directly to (e.g., a memory of) one or more GPU(s) 1408.

The I/O ports 1412 may allow the computing device 1400 to be logically coupled to other devices including the I/O components 1414, the presentation component(s) 1418, and/or other components, some of which may be built in to (e.g., integrated in) the computing device 1400. Illustrative I/O components 1414 include a microphone, mouse, keyboard, joystick, game pad, game controller, satellite dish, scanner, printer, wireless device, etc. The I/O components 1414 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 1400. The computing device 1400 may be include depth cameras, such as stereoscopic camera systems, infrared camera systems, RGB camera systems, touchscreen technology, and combinations of these, for gesture detection and recognition. Additionally, the computing device 1400 may include accelerometers or gyroscopes (e.g., as part of an inertia measurement unit (IMU)) that allow detection of motion. In some examples, the output of the accelerometers or gyroscopes may be used by the computing device 1400 to render immersive augmented reality or virtual reality.

The power supply 1416 may include a hard-wired power supply, a battery power supply, or a combination thereof. The power supply 1416 may provide power to the computing device 1400 to allow the components of the computing device 1400 to operate.

The presentation component(s) 1418 may include a display (e.g., a monitor, a touch screen, a television screen, a heads-up-display (HUD), other display types, or a combination thereof), speakers, and/or other presentation components. The presentation component(s) 1418 may receive data from other components (e.g., the GPU(s) 1408, the CPU(s) 1406, DPUs, etc.), and output the data (e.g., as an image, video, sound, etc.).

### Example Data Center

FIG. 15 illustrates an example data center 1500 that may be used in at least one embodiments of the present disclosure. In at least one embodiment, the data center 1500 may include one or more computing devices configured to select one or more draft sets of tokens to be input into one or more neural networks based at least on multiple amounts of processing time and multiple numbers of accepted tokens associated with multiple numbers of tokens, cause the one or more neural networks to use the one or more draft sets of tokens to generate one or more predictions, and/or perform one or more other operations such as those described herein. The data center 1500 may include a data center infrastructure layer 1510, a framework layer 1520, a software layer 1530, and/or an application layer 1540.

As shown in FIG. 15, the data center infrastructure layer 1510 may include a resource orchestrator 1512, grouped computing resources 1514, and node computing resources (“node C.R.s”) 1516(1)-1516(N), where “N” represents any whole, positive integer. In at least one embodiment, node C.R.s 1516(1)-1516(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 1516(1)-1516(N) may correspond to a server having one or more of the above-mentioned computing resources. In addition, in some embodiments, the node C.R.s 1516(1)-15161(N) may include one or more virtual components, such as vGPUs, vCPUs, and/or the like, and/or one or more of the node C.R.s 1516(1)-1516(N) may correspond to a virtual machine (VM).

In at least one embodiment, grouped computing resources 1514 may include separate groupings of node C.R.s 1516 housed within one or more racks (not shown), or many racks housed in data centers at various geographical locations (also not shown). Separate groupings of node C.R.s 1516 within grouped computing resources 1514 may include grouped compute, network, memory or storage resources that may be configured or allocated to support one or more workloads. In at least one embodiment, several node C.R.s 1516 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 1512 may configure or otherwise control one or more node C.R.s 1516(1)-1516(N) and/or grouped computing resources 1514. In at least one embodiment, resource orchestrator 1512 may include a software design infrastructure (SDI) management entity for the data center 1500. The resource orchestrator 1512 may include hardware, software, or some combination thereof.

In at least one embodiment, as shown in FIG. 15, framework layer 1520 may include a job scheduler 1528, a configuration manager 1534, a resource manager 1536, and/or a distributed file system 1538. The framework layer 1520 may include a framework to support software 1532 of software layer 1530 and/or one or more application(s) 1542 of application layer 1540. The software 1532 or application(s) 1542 may respectively include web-based service software or applications, such as those provided by Amazon Web Services, Google Cloud and Microsoft Azure. The framework layer 1520 may be, but is not limited to, a type of free and open-source software web application framework such as Apache Spark™ (hereinafter “Spark”) that may use distributed file system 1538 for large-scale data processing (e.g., “big data”). In at least one embodiment, job scheduler 1528 may include a Spark driver to facilitate scheduling of workloads supported by various layers of data center 1500. The configuration manager 1534 may be capable of configuring different layers such as software layer 1530 and framework layer 1520 including Spark and distributed file system 1538 for supporting large-scale data processing. The resource manager 1536 may be capable of managing clustered or grouped computing resources mapped to or allocated for support of distributed file system 1538 and job scheduler 1528. In at least one embodiment, clustered or grouped computing resources may include grouped computing resource 1514 at data center infrastructure layer 1510. The resource manager 1536 may coordinate with resource orchestrator 1512 to manage these mapped or allocated computing resources.

In at least one embodiment, software 1532 included in software layer 1530 may include software used by at least portions of node C.R.s 1516(1)-1516(N), grouped computing resources 1514, and/or distributed file system 1538 of framework layer 1520. One or more types of software may include, but are not limited to, Internet web page search software, e-mail virus scan software, database software, and streaming video content software.

In at least one embodiment, application(s) 1542 included in application layer 1540 may include one or more types of applications used by at least portions of node C.R.s 1516(1)-1516(N), grouped computing resources 1514, and/or distributed file system 1538 of framework layer 1520. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 1534, resource manager 1536, and resource orchestrator 1512 may implement any number and type of self-modifying actions based on any amount and type of data acquired in any technically feasible fashion. Self-modifying actions may relieve a data center operator of data center 1500 from making possibly bad configuration decisions and possibly avoiding underutilized and/or poor performing portions of a data center.

The data center 1500 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 1500. In at least one embodiment, trained or deployed machine learning models corresponding to one or more neural networks may be used to infer or predict information using resources described above with respect to the data center 1500 by using weight parameters calculated through one or more training techniques, such as but not limited to those described herein.

In at least one embodiment, the data center 1500 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services. In at least one embodiment, one or more software and/or hardware resources of the data center 1500 may cause one or more neural networks to be trained to increase their acceptance rates of tokens using augmented data as described herein. Furthermore, one or more software and/or hardware resources of the data center 1500 may cause one or more draft sets of tokens to be selected to be input into one or more neural networks based at least on multiple amounts of processing time and multiple numbers of accepted tokens associated with multiple numbers of tokens, cause the one or more neural networks to use the one or more draft sets of tokens to generate one or more predictions, and/or perform one or more other operations such as those described herein.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the computing device(s) 1400 of FIG. 14—e.g., each device may include similar components, features, and/or functionality of the computing device(s) 1400. In addition, where backend devices (e.g., servers, NAS, etc.) are implemented, the backend devices may be included as part of a data center 1500, an example of which is described in more detail herein with respect to FIG. 15.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example computing device(s) 1400 described herein with respect to FIG. 14. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

In at least one embodiment, one or more circuits can be used to select one or more draft sets of tokens to be input into one or more neural networks based at least on multiple amounts of processing time and multiple numbers of accepted tokens associated with multiple numbers of tokens, cause the one or more neural networks to use the one or more draft sets of tokens to generate one or more predictions, and/or perform one or more other operations such as those described herein. One or more neural networks and training frameworks can be configured by software to select one or more draft sets of tokens to be input into one or more neural networks based at least on multiple amounts of processing time and multiple numbers of accepted tokens associated with multiple numbers of tokens, cause the one or more neural networks to use the one or more draft sets of tokens to generate one or more predictions, and/or perform one or more other operations such as those described herein.

At least one embodiment of the disclosure can be described in view of the following clauses:
Clause 1. One or more processors comprising processing circuitry to:
select one or more draft sets of one or more tokens to be input into one or more neural networks based at least on multiple amounts of processing time and multiple numbers of accepted tokens associated with multiple numbers of tokens; and
cause the one or more neural networks to use the one or more draft sets to generate one or more predictions.
Clause 2. The one or more processors of clause 1, wherein the processing circuitry is to: compute multiple marginal costs based at least on the multiple amounts of processing time, the processing circuitry to use the multiple marginal costs to select the one or more draft sets.
Clause 3. The one or more processors of clause 1 or 2, wherein the processing circuitry is to: compute multiple marginal profits based at least on the multiple numbers of accepted tokens, the processing circuitry to use the multiple marginal profits to select the one or more draft sets.
Clause 4. The one or more processors of any one of clauses 1-3, wherein the processing circuitry is to: compute multiple ratios based at least on multiple marginal costs associated with the multiple amounts of processing time and multiple marginal profits associated with the multiple numbers of accepted tokens, the processing circuitry to use the multiple ratios to select the one or more draft sets.
Clause 5. The one or more processors of any one of clauses 1-4, wherein the one or more draft sets are selected based at least on a comparison of a threshold value to a ratio of marginal profit to marginal cost.
Clause 6. The one or more processors of any one of clauses 1-5, wherein the one or more draft sets comprise a plurality of draft sets comprising a plurality of draft set lengths, and the processing circuitry is to: input the plurality of draft sets into the one or more neural networks in parallel.
Clause 7. The one or more processors of any one of clauses 1-6, wherein the one or more neural networks were trained to perform lookahead speculative decoding using a training dataset augmented with input sequences including tokens sampled from at least a portion of a training sequence.
Clause 8. The one or more processors of any one of clauses 1-7, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or a system implemented at least partially using cloud computing resources.
Clause 9. A system comprising one or more processors to:
select one or more of a plurality of draft sets to be input into one or more neural networks based at least on multiple amounts of processing time and multiple numbers of accepted tokens associated with multiple numbers of tokens, the one or more neural networks to use the one or more draft sets to generate one or more predictions.
Clause 10. The system of clause 9, wherein the one or more processors are to obtain a particular one of the multiple amounts of processing time for a particular number of tokens of the multiple numbers of tokens by:
calculating a first average amount of processing time per token based at least in part on one or more first amounts of time used to process one or more first previous batches of draft sets each comprising up to the particular number of tokens;
calculating a second average amount of processing time per token based at least in part on one or more second amounts of time used to process one or more second previous batches of draft sets each comprising up to one fewer than the particular number of tokens; and subtracting the second average amount of processing time per token from the first average amount of processing time per token.
Clause 11. The system of clause 9 or 10, wherein the one or more processors are to obtain a particular one of the multiple numbers of accepted tokens associated with a particular number of tokens of the multiple numbers of tokens by:
obtaining a total value by totaling tokens accepted, with respect to a plurality of predictions, that have a token at a position corresponding to the particular number of tokens; and
dividing the total value by a number of predictions in the plurality of predictions.
Clause 12. The system of any one of clauses 9-11, wherein the one or more processors are to:
calculate multiple marginal costs for the multiple numbers of tokens based at least in part on the multiple amounts of processing time; and
calculate multiple marginal profits for the multiple numbers of tokens based at least in part on the multiple numbers of accepted tokens, wherein the one or more processors are to select the one or more draft sets based at least in part on the multiple marginal costs and the multiple marginal profits.
Clause 13. The system of any one of clauses 9-12, wherein the one or more processors are to:
compute a ratio for a particular draft set of the one or more draft sets based at least on a particular one of the multiple amounts of processing time associated with a number of tokens included in the particular draft set and a particular one of the multiple numbers of accepted tokens associated with the number of tokens included in the particular draft set; and
include the particular draft set in the one or more draft sets based on a comparison of the ratio to a threshold value.
Clause 14. The system of any one of clauses 9-13, wherein the one or more processors are to: train the one or more neural networks to perform lookahead speculative decoding using a training dataset augmented with input sequences including sampled tokens that were sampled from at least a portion of a training sequence.
Clause 15. The system of clause 14, wherein the training sequence comprises a current token positioned immediately before a golden token, and training the one or more neural networks comprises sampling at least a portion of the sampled tokens from a portion of the training sequence positioned after the current token, and training the one or more neural networks to predict the golden token for the input sequences.
Clause 16. The system of clause 14 or 15, wherein training the one or more neural networks comprises calculating a loss value based at least part on output generated for the input sequences, and
updating at least one parameter of the one or more neural networks based at least in part on the loss value.
Clause 17. The system of any one of clauses 9-16, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
Clause 18. A method comprising:
selecting one or more selected draft sets of one or more tokens to be input into one or more neural networks based at least on multiple amounts of processing time and multiple numbers of accepted tokens associated with multiple numbers of tokens included in the one or more selected draft sets; and
causing the one or more neural networks to use the one or more selected draft sets to generate one or more predictions.
Clause 19. The method of clause 18, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.
Clause 20. The method of clause 18 or 19, further comprising:
obtaining multiple marginal profit values calculated for the multiple numbers of tokens; and
   selecting a particular one of a plurality of draft sets for inclusion in the one or more selected draft sets if the particular draft set comprises a first number of tokens corresponding to a largest one of the multiple marginal profit values.
Clause 21. The method of clause 20, further comprising: omitting one or more of the plurality of draft sets from the one or more selected draft sets based at least in part on a comparison of a threshold value to a ratio of one of the multiple marginal profit values calculated for a second number of tokens associated with the omitted one or more draft sets, and a marginal cost associated with the second number of tokens.
Clause 22. The method of any one of clauses 18-21, wherein the one or more selected draft sets comprise a plurality of draft sets input to the one or more neural networks in parallel to be used to generate the one or more predictions in parallel.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

What is claimed is:

1. One or more processors comprising processing circuitry to:
select one or more draft sets of one or more tokens to be input into one or more neural networks based at least on multiple amounts of processing time and multiple numbers of accepted tokens associated with multiple numbers of tokens; and
cause the one or more neural networks to use the one or more draft sets to generate one or more predictions.

2. The one or more processors of claim 1, wherein the processing circuitry is to:
compute multiple marginal costs based at least on the multiple amounts of processing time, the processing circuitry to use the multiple marginal costs to select the one or more draft sets.

3. The one or more processors of claim 1, wherein the processing circuitry is to:
compute multiple marginal profits based at least on the multiple numbers of accepted tokens, the processing circuitry to use the multiple marginal profits to select the one or more draft sets.

4. The one or more processors of claim 1, wherein the processing circuitry is to:
compute multiple ratios based at least on multiple marginal costs associated with the multiple amounts of processing time and multiple marginal profits associated with the multiple numbers of accepted tokens, the processing circuitry to use the multiple ratios to select the one or more draft sets.

5. The one or more processors of claim 1, wherein the one or more draft sets are selected based at least on a comparison of a threshold value to a ratio of marginal profit to marginal cost.

6. The one or more processors of claim 1, wherein the one or more draft sets comprise a plurality of draft sets comprising a plurality of draft set lengths, and the processing circuitry is to:
input the plurality of draft sets into the one or more neural networks in parallel.

7. The one or more processors of claim 1, wherein the one or more neural networks were trained to perform lookahead speculative decoding using a training dataset augmented with input sequences including tokens sampled from at least a portion of a training sequence.

8. The one or more processors of claim 1, wherein the one or more processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

9. A system comprising one or more processors to:
select one or more of a plurality of draft sets to be input into one or more neural networks based at least on multiple amounts of processing time and multiple numbers of accepted tokens associated with multiple numbers of tokens, the one or more neural networks to use the one or more draft sets to generate one or more predictions.

10. The system of claim 9, wherein the one or more processors are to obtain a particular one of the multiple amounts of processing time for a particular number of tokens of the multiple numbers of tokens by:
calculating a first average amount of processing time per token based at least in part on one or more first amounts of time used to process one or more first previous batches of draft sets each comprising up to the particular number of tokens;
calculating a second average amount of processing time per token based at least in part on one or more second amounts of time used to process one or more second previous batches of draft sets each comprising up to one fewer than the particular number of tokens; and
subtracting the second average amount of processing time per token from the first average amount of processing time per token.

11. The system of claim 9, wherein the one or more processors are to obtain a particular one of the multiple numbers of accepted tokens associated with a particular number of tokens of the multiple numbers of tokens by:
obtaining a total value by totaling tokens accepted, with respect to a plurality of predictions, that have a token at a position corresponding to the particular number of tokens; and
dividing the total value by a number of predictions in the plurality of predictions.

12. The system of claim 9, wherein the one or more processors are to:
calculate multiple marginal costs for the multiple numbers of tokens based at least in part on the multiple amounts of processing time; and
calculate multiple marginal profits for the multiple numbers of tokens based at least in part on the multiple numbers of accepted tokens, wherein the one or more processors are to select the one or more draft sets based at least in part on the multiple marginal costs and the multiple marginal profits.

13. The system of claim 9, wherein the one or more processors are to:
compute a ratio for a particular draft set of the one or more draft sets based at least on a particular one of the multiple amounts of processing time associated with a number of tokens included in the particular draft set and a particular one of the multiple numbers of accepted tokens associated with the number of tokens included in the particular draft set; and
include the particular draft set in the one or more draft sets based on a comparison of the ratio to a threshold value.

14. The system of claim 9, wherein the one or more processors are to:
train the one or more neural networks to perform lookahead speculative decoding using a training dataset augmented with input sequences including sampled tokens that were sampled from at least a portion of a training sequence.

15. The system of claim 14, wherein the training sequence comprises a current token positioned immediately before a golden token, and training the one or more neural networks comprises sampling at least a portion of the sampled tokens from a portion of the training sequence positioned after the current token, and training the one or more neural networks to predict the golden token for the input sequences.

16. The system of claim 14, wherein training the one or more neural networks comprises calculating a loss value based at least part on output generated for the input sequences, and
updating at least one parameter of the one or more neural networks based at least in part on the loss value.

17. The system of claim 9, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

18. A method comprising:
selecting one or more selected draft sets of one or more tokens to be input into one or more neural networks based at least on multiple amounts of processing time and multiple numbers of accepted tokens associated with multiple numbers of tokens included in the one or more selected draft sets; and
causing the one or more neural networks to use the one or more selected draft sets to generate one or more predictions.

19. The method of claim 18, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more multi-model language models (MMLMs);
a system implementing one or more large language models (LLMs);
a system implementing one or more vision language models (VLMs);
a system for generating synthetic data;
a system for generating synthetic data using AI;
a system incorporating one or more virtual machines (VMs);
a system implemented at least partially in a data center; or
a system implemented at least partially using cloud computing resources.

20. The method of claim 18, further comprising:
obtaining multiple marginal profit values calculated for the multiple numbers of tokens; and
selecting a particular one of a plurality of draft sets for inclusion in the one or more selected draft sets if the particular draft set comprises a first number of tokens corresponding to a largest one of the multiple marginal profit values.
